(19) United States
(12) Patent Application Publication
(10) Pub. No.: US 2023/0000003 A1
(43) Pub. Date: Jan. 5, 2023

(54) Implement Attachment Apparatus, Power Take-Off With Safety System and Method Thereof

(71) Applicants: Georgios Chrysanthakopoulos, Seattle, WA (US); Adlai Felser, Seattle, WA (US)

(72) Inventors: Georgios Chrysanthakopoulos, Seattle, WA (US); Adlai Felser, Seattle, WA (US)

(73) Assignee: dCentralized Systems, Inc., Seattle, WA (US)

(21) Appl. No.: 17/931,532

(22) Filed: Sep. 12, 2022

Related U.S. Application Data
(62) Division of application No. 16/208,506, filed on Dec. 3, 2018, now abandoned.

(51) Int. Cl. A01B 59/043; G05D 1/02; G05D 1/00; E01H 5/06; A01M 21/04; B62D 49/06; B60K 17/28; B60K 1/04

(52) U.S. Cl. CPC A01B 59/043; G05D 1/0246; G05D 1/0011; E01H 5/061; A01M 21/046; B62D 49/065; G05D 1/0214; B60K 17/28; B60K 1/04; G05D 1/0242; B60Y 2200/91; B60Y 2300/09; B60Y 2300/28; B60Y 2400/112; G05D 1/0278; G05D 2201/0201; G05D 1/0219; B60L 8/003

(57) ABSTRACT

A ground utility robot and implement attachment apparatus having a ground utility robot, at least one implement, at least one solar panel, at least one battery that is chargeable by the at least one solar panel, a power take-off system that is connected to the ground utility robot and to the at least one implement; where the battery powers said ground utility robot and the implement; a safety system that has a computer, a safety program that utilizes a processing logic on the computer, where the safety program initiates precautionary measures that are carried out by the ground utility robot and the power take-off system if an object comes within a predefined distance from the ground utility robot and implement attachment apparatus.

### RELATED APPLICATION

This application claims the benefit of U.S. provisional patent application Ser. No. 62/612,297, filed 2017 Dec. 29 and entitled AUTONOMOUS MODULAR GROUND UTILITY ROBOT SYSTEM, U.S. non-provisional patent application Ser. No. 16/024,450 filed 2018 Jun. 29 entitled AUTONOMOUS MOBILE PLATFORM WITH HARVESTING SYSTEM AND PEST AND WEED SUPPRESSION SYSTEMS, and U.S. Design patent application Ser. No. 29/665,575, filed 2018 Oct. 4, entitled AUTONOMOUS MOBILE PLATFORM, and U.S. non-provisional patent application Ser. No. 16/208,506 filed 2018 Dec. 3 entitled IMPLEMENT ATTACHMENT APPARATUS AND POWER TAKE-OFF, which are all incorporated herein by reference.

### FIELD OF THE INVENTION

The current invention relates to a robot system that can utilize a power-take-off, or PTO, and can control the PTO. In a preferred embodiment the PTO is securely affixed to a ground utility robot unit, or GURU, and the GURU then provides power to the PTO and an onboard computer system controls the PTO. It also relates to using the robots as cooperative or collaborative units whereby the robots can be used in unison to perform tasks that an individual robot cannot perform; or to assist other robots when needed, such as when a robot gets stuck in a field and needs assistance with movement, or a task; or to take over when another robot runs out of charge or fails to perform for whatever reason. This cooperative robot system is useful when used in conjunction with the PTO system.

The invention relates first to the field of autonomous, modular, ground utility robot units, or GURU, to perform tasks. Nothing currently exists that is truly similar to the embodiments disclosed herein. In one embodiment the GURU accepts attachments that perform tasks, such as snow removal, or in as with the present invention, the Power Take-off unit and a wide variety of implements that attach to and work in conjunction with the PTO. In another embodiment the GURU is capable of moving cargo around. In another embodiment the GURU accepts payloads, such as a focused energy apparatus attachment that utilizes focused energy beams or lenses to focus light to perform a variety of tasks, such as weed suppression and control, pest or insect control, crop harvesting, and predator control. In yet another embodiment the payload weed suppression attachment apparatus is a screw device that will eradicate or remove a weed. In this application the attachment system is the PTO, that can be attached to either end of the GURU and that then accepts implements. In all applications the systems preferably utilize clean sources of energy, and the entire systems are made from recycled or easily recycled materials and parts.

Further, it is an autonomous robot system comprising an autonomous robot, allocation software that will allow a user to log onto a platform and enter information so that the control company can compile the information and then allocate the robots to the job. Once the robots are delivered to the job the system further has software that will allow the robot to navigate in either a structured or unstructured environment where the robot can perform a variety of tasks. These tasks are supplied by, overseen, monitored and managed by the control company. It is also possible that there will be a system that can collect energy and utilize the energy either to run the robots, and in this case, the PTO, on the work site or to use the energy to power robots at other proximate sites. Finally, it is an autonomous robot system that has the control company or means to deliver the robots to their jobs, to maintain the robots while at the job, to collect data, to collect energy when a site is so configured, and to generally oversee, run and maintain the entire robot system operation.

### BACKGROUND INFORMATION

There is a great need to have robots assist in our daily lives. As technology moves forward it is now envisionable that robots can and will perform many of the tasks and chores that we as humans routinely perform in our daily lives. Already used abundantly in manufacturing, the personal “bot” has not quite made it into our lives much past the Roomba® cleaner by iRobot®. There are multitudes of applications for a mobile robot, including but not limited to room vacuuming, snow removal, transporter, ground aeration, plant watering, feeding and fertilizing, crop monitoring, weed control, pest control—both large and small (eliminating small bugs, along with scaring off larger predators) corn de-tasseling, crop harvesting (which might include picking beans, berries, apples, pears, grapes, etc.), grounds security, weather reporting, livestock surveillance and monitoring (for example, if an animal in the pasture is sick or injured the bot could report back to the farmer that there is a problem), debris cleanup and removal and a variety of other tasks and chores now performed manually by humans. Thus, there is a great need to have bots assist us in our daily lives.

It is clear from research that there is a great need to reduce weeds in order to protect food crops because weeds reduce yields due to the fact that they steal water, nutrients, and sunlight from food crops. This represents a significant challenge to all growers. One source states, “Currently, weed control is ranked as the number one production cost by organic and many conventional growers” see Fundamentals of Weed Science, 4^{th} edition, Robert L. Zimdahl, page 308 incorporated herein by this reference. Furthermore, the weed problem is worsening as weeds become resistant to common herbicides.

Mechanical eradication of weeds could solve or at least minimize the problem of herbicide resistance. Accordingly, this strategy has been pursued by many. The challenges are constructing cost-effective implements able to discriminate between weeds and desired crops and to find solutions to efficiently and economically remove weeds. In addition, mechanical weeding disturbs the soil, drying it out and actually encouraging weed growth by stimulating the weed seed bank. Purely mechanical methods are available commercially but are limited in scope. Vision-based methods have not yet proven commercially successful possibly because of the great similarity between weeds and crops during some parts of the growth cycle. See also U.S. Published Patent Application Serial No. 2013/0345876 and U.S. Pat. Nos. 5,442,552 and 8,381,501 all incorporated herein by this reference.

There is also a great need to reduce and control pests. Insects routinely feast on plants, endangering crops and costing billions annually. By some estimates insects cost the US alone around $120 billion annually. Many of these damages are caused by insects that are not native to the US, but rather those that come in through travelers. However, unless we cease travel or cease raising crops, insects will continue to be an issue.

Next, there is a great need to find ways to harvest crops. Although we have many crops that are harvested using large machinery, there still exists many industries where crops are harvested by hand, including tomatoes, lettuce and spinach, cherries, apples, peppers, almond trees, and many other fruits and nuts. In addition to harvesting crops there are a wide variety of chores that are currently performed on farms and elsewhere that utilize implements that are attached to tractors and that utilize the PTO. These are often dangerous machines and humans are often injured due to the required interaction with these devices. Currently there are no known GURU that can accept farming implements that are powered through a connectable PTO. Nor are there any GURU that can control implements through computer systems and software.

There is also a need to have robots perform daily tasks, such as moving items around a farm, delivering supplies to a farmer in the field, moving debris from one location to another using a “follow me” function. This “follow me” function is extremely useful and could assist farmers and homeowners alike. A cumbersome task such as hauling a load of dirt from the front to the rear of a property could easily be performed by a bot having the “follow me” function programmed.

The robots could also perform other functions, such as providing security to farm lands through the use of sirens or other non-invasive, non-lethal means; preventing predators from attacking livestock using the same non-lethal means; monitoring the health of livestock through images and video; weather monitoring using onboard sensors; aerating soil by injecting prongs into the soil as the bots move about; and a variety of other chores and operations. Thus, the bot could become the modern-day work horse of the farm.

The foregoing discussion is intended only to illustrate various aspects of certain embodiments disclosed in the present disclosure and should not be taken as a disavowal of claim scope.

### SUMMARY OF THE INVENTION

The present invention desires to provide a robotics solution to trailering and to implement utilization. Implement connection can be accomplished by using a standard receiver type hitch and shank, or, alternatively, in the form of a three-point tractor hitch that connects directly through dedicated connections to the GURU or that uses the receiver of the receiver type hitch as a securement apparatus for attaching the three-point hitch via an integrated shank. It further desires to provide a robotics solution to provide power from the GURU to the implement. This power can be provided from connections on one or both ends of the GURU and ideally this power is provided by the onboard battery, solar panels or any other power generation apparatus on the GURU. It could be a combustion engine, but this is not preferred. The implements are used to eradicate weeds, eliminate or minimize pests, harvest crops, cut grass or hay, plow, till, cut and harvest crops, move cargo around, aerate soil, provide security, and to performing a multitude of other tasks, jobs and functions as programmed, all using robots that are made from organic, recyclable, interchangeable parts such that if one bot fails it can easily be repaired using parts from spare bots or from new, interchangeable parts. Ideally, the controls for these implements come from an onboard computer and are programed by a control company.

An issue or possible problem with using a single robot to perform some of these functions is that some of the tasks require multiple robots. For example, when harvesting plants, it is difficult to have one robot both pick and carry the produce. It is better to have one robot perform the cutting function and another perform the carry function. In addition, there are times when a robot requires assistance. For example, if one robot does not have enough power to pull a load up a hill it could be possible for another robot to come and assist. Also, with respect to the PTO application, these additional cooperative bots could be used to clear jams in an implement so that human interaction is minimized. These cooperative robots are an important element of this invention.

To perform many of these tasks the robots need to be trained to do a specific task. Currently there does not exist a way to obtain or gather this large data set. Another aspect of this invention involves human assisted machine learning whereby humans assist the robots while they are learning the task. As multiple humans assist the data base is concurrently constructed and the bots are trained.

In addition to the need to have the bots there is also a need for a system to deploy, command, control and monitor the bots. This system starts with a customer ordering a bot or multiple bots to perform a certain function or functions, followed by a control company delivering the robots to the customer. Next, having the control company oversee, manage, instruct, assign tasks, repair, replace the robots while they are performing their functions or duties, and finally, having the control company retrieve the bots from the customer for delivery to the next job.

The bots are able to negotiate around rural terrain and using either mechanical or an energy beam control system mounted to the bot or to other mobile devices, can perform a variety of tasks. Specifically, to control weeds; to control pests; to harvest crops; to utilize the PTO to perform a wide variety of tasks. This application deals specifically with the use of the power take-off, its mechanical components, energy source and utilizing and controlling the apparatus and the implements attached to the PTO. This application also deals with the deployment, autonomous navigation patterns and cooperative behavior of a multitude of robots that perform tasks independent of human involvement. And finally, this application deals with the means to manage and control the bots, the power take-off and the implements.

### BRIEF DESCRIPTION OF THE DRAWINGS

FIG. 1 is a perspective view of a GURU of a previous invention.

FIG. 2 is a perspective view of the GURU of the previous invention using a trailer hitch and a trailer hitch attachment.

FIG. 3 is a perspective view of a different embodiment of the GURU, a fueling docking station and a user.

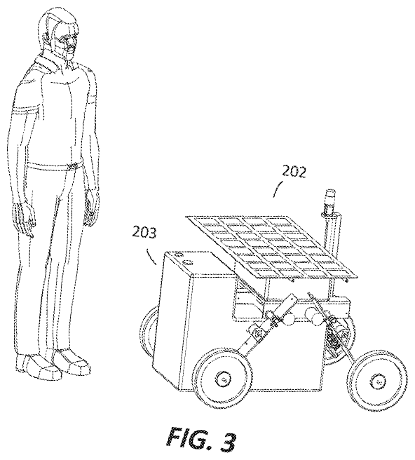

FIG. 4 is a perspective view of a different embodiment of the GURU.

FIG. 5 is a block diagram explaining the GURU.

FIG. 6 is a perspective view of the GURU with a trailer hitch attachment and another GURU performing a follow me function.

FIG. 7 is a perspective view of the GURU with an object, physical marker and a human, showing the human assisted machine learning system.

FIG. 8 is a flow chart showing GURU operation.

FIG. 9 is a flow chart showing the operational steps taken to eliminate weeds or pests.

FIG. 10 is a flow chart showing the steps performed for human assisted machine learning.

FIG. 11 is a side view of the present invention with a common mower deck attached to the back of a GURU unit of the present invention, driven by the PTO and a counterweight affixed to the front of the GURU.

FIG. 12 is a side view of the present invention with a common mower deck attached to the first end of the GURU unit and driven by the PTO.

FIG. 13 is side view with a wheel removed to show the attachment of the three-point hitch system to the GURU

FIG. 14 is a perspective view of the present invention from the rear with the three-point hitch system attached to the GURU.

FIG. 15 is a side view of the present invention three-point hitch system by itself.

FIG. 16 is an exploded view showing the integration of the modular PTO unit with the three-point hitch system.

FIG. 17 is a view of the gearing mechanism of the current invention.

FIG. 18 is a rear view of the three-point hitch system of the present invention.

The exemplifications set out herein illustrate various embodiments, in several forms, and such exemplifications are not to be construed as limiting the scope of the appended claims in any manner.

### DETAILED DESCRIPTION OF THE INVENTION

The following detailed description teaches the now current preferred embodiments of the invention. However, it is noted that the claims and this invention are not limited by these descriptions. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and illustrative. Variations and changes thereto may be made without departing from the scope of the claims.

The terms “comprise” and any form of comprise, such as “comprises” and “comprising”, “have” and any form of have, such as “has” and “having”, “include” and any form of include, such as “includes” and “including” and “contain” and any form of contain, such as “contains” and “containing” are open-ended linking verbs. As a result, a system, device, or apparatus that “comprises,” “has,” “includes” or “contains” one or more elements possesses those one or more elements but is not limited to possessing only those one or more elements. Likewise, an element of a system, device, or apparatus that “comprises,” “has,” “includes” or “contains” one or more features possesses those one or more features but is not limited to possessing only those one or more features.

### Allocation and Reservation System, Data Control System and Method Using a Control Company

In order to make all of the following described inventions work there needs to be a means, system or method to get the robots into the field and out to the customers and to control the tasks they are to perform. This will be described more fully below, but in general, the system includes an entire method and system to reserve bots, deploy bots, maintain bots and to retrieve bots and to assign and monitor tasks. In addition, there is a system to collect, manage, sort, arrange, configure, utilize and store data. The reservation system is an entire method having the steps of having a customer either downloading a computer or mobile device application, or logging onto a reservations website, inputting data, a control company receiving the data, the control company analyzing the data, the control company utilizing the data and control company's own data collection to provide a service estimate to the customer based on the data analysis, control company compiling a second data set based on a second real-time data collection of weather and land for real-time analysis, providing a final estimate to the customer, customer accepts or rejects offer, if customer accepts estimate then control company deploys robots to the customer, unloads robots at customer's site, and robots begin completing assigned tasks. After the tasks are completed, the control company returns to the customer site and retrieves and removes robots from the site. The robots are then either returned to a storage facility or are moved to another customer's job site.

More specifically, the control company oversees and manages the robots for the customers, i.e., the farmers or individual customers, so that the customers are not responsible for maintaining and servicing the robots. The control company will provide multiple services and these services can include but are not limited to: bot reservations, delivery of robots when needed, providing technical support when needed, providing mechanical support and repair services for robots when needed so that the robots are continually operational, attending to software updates, overseeing general maintenance, assisting with data analysis (this could include weather forecasting, forecasting how many robot units will be needed for the next growing season, if robots should remain on the property for continued weather monitoring, predator monitoring, etc.) retrieving robots when their mission and duties are complete, and possibly assisting with the energy needs of the consumer and the robots. Another function of the control company is to assign tasks, oversee the tasks, and to make sure that the tasks are completed. In addition, the control company will collect, sort, organize, manage, utilize and store a multitude of data collected while the bots are on site performing their tasks. This data is utilized for future assignments to the same customer, and to help estimate and provide information to customers in the general vicinity.

All of the above referenced systems and apparatus rely on the control company. The control company starts with reservations and the reservations software. The reservation software is accessible by the customer so that the customer can reserve robots and schedule delivery. This is started by the customer inputting a customer identifier, specifying a location and date, and setting a timeline of what needs to be accomplished. This timeline will depend on the type of service required, such as weed suppression, de-tasseling corn, applying pesticide, applying fertilizer, pest control, or any of the number of chores or tasks required and that can be provided by the bots. The software system applies the collected data and combines reservations from a multitude of customers to minimize the transport of robots between set locations. Next, the software allocates the number of robots required at each location and schedules the bots based on the number of requests, the tasks requested, and the acreage or amount of land requiring service. The software also creates alerts of an event that is sent to an operator or an autonomous vehicle that loads the required number of robots at a specified date created from the information inputted by the customer.

Each reservation begins with the customer utilizing a scheduling wizard. The customer inputs a variety of data, such as parcel number, address, crops grown, tasks required, preferred access to the property with predefined ingress and egress, and any other data deemed necessary for proper task execution and entry and eventual bot removal. It is also possible to automatically use gps and other systems to map the property and fields and to come up with a schedule, boundaries and paths for the robots to follow. The software compiles all the data and information and creates a customer profile.

This same software enables the control company to create cost and time estimates for each schedule. After the scheduling there is an onboarding operation that takes place once a year. In order to arrive at a cost estimate the system takes a multitude of data into account, including but not limited to historical weather data for the service area. Next, the system considers any data provided by the farmer or customer. Also, the system considers past data and success rates moving forward. Looking at the past weather information, customer information and past customer work data is helpful to obtain the best time to perform the desired tasks. Combining all of this information and whatever other data can be compiled the system generates a cost based on the number of bots required and the time allocation for the desired work performed and is delivered to the customer prior to final scheduling. At this time the customer can input his payment information and secure the reservation for robot delivery.

When the time comes for the robot delivery the system again analyzes the weather conditions, this time in real time, to compare with the prior data generated estimates and calculates a better, real time estimate of time and robots required to perform the tasks. At this point the system generates an estimate of renewable energy, typically solar, for the duration of the task. This second notification is sent to the customer for a real time estimate of energy required for completion. This is important as if, for example, the prior estimate was based on sunshine every day, but at the time of actual work there are clouds, storms and inclement weather. This affects the energy collection and possibly the time required for the job's completion.

After the customer confirms scheduling and delivery date the robots are set for delivery. At this time an alert or notification is again sent to the customer indicating arrival time. Another alert is sent to either a human operator or an autonomous vehicle that it is time to deliver the bots. The bots are collected from a main storage area where they are kept for storage, repair, charging, maintenance and upgrades, or they are collected and delivered from a nearer location where they were previously deployed, such as a neighboring farm. Once they arrive at the designated work area, or field, they exit the delivery vehicle and are sent to the field, thus entering the on-field operation stage. The bots then use the pre-assigned entrance routes collected from the customer to navigate to and through the field and to their assigned work areas. Then, an operator or software, confirms robot location through visual or gps data. The robot, because of built-in software, also knows it is where it is supposed to be. At this point the bot and the software shake hands to confirm that the bot is in the appropriate location to perform the tasks and the bots are then placed in autonomous mode, either by the local operator or automatically via the software. The control company assigns the tasks required of each bot and once delivered they go to work and operate continuously until their tasks are completed. The only restriction or limitation is their battery capacity and available solar energy collectable at the time of operation.

Once on the field and running the bots continue to communicate with each other. If cloud connectivity is available, then they post real time data to the cloud. This is not a requirement however as they can always connect up later and upload data at a later time. The software systems running within each robot performs real time updates with the other robots that are part of the same communication group using a local wi-fi hotspot, provided by consumer grade cell phones. The robots form an ad-hoc communication mesh network so that they can communicate with each other and so they can monitor each other's progress and health. Through this system they know if there are any issues with other bots or anomalies in the system.

If an error, anomaly, bot health or other problem is detected then the bots perform a variety of response actions. Typically, a problem would require one bot go and assist the failed bot. In order for the bots to decide which one should go they will perform one of several actions. A first way to decide which bot should go and assist is to perform an election. In this scenario the able-bodied bots share and compare information, such as their location and proximity to the downed bot, the ease of access to the downed bot, or any other information that allows the bots to choose which bot should lend assistance.

Alternatively, the bots can perform a random drawing to see which bot takes over the task of the failed bot. This choice may however cause one of the most inaccessible bots to have to come a long distance to help out.

These options allow one or more bots to lend assistance. If a disabled bot is down, not because of a failed battery or software issue, but is simply stuck, then other bots could come to the rescue by pulling, pushing or attempting to free it from its “stuck” situation. If assistance is futile and the bot remains stuck then one or more of the bots could send a distress signal to the human operator or to the operating software to notify a human operator of the situation so that sufficient resources, such as a human assistant, can be sent to find, retrieve and repair the downed bot.

Similar to the assistance lent to downed bots, the bots can communicate with each other and lend assistance if one bot is behind with its' assigned task. Once a bot completes its' assigned task it communicates with the other bots to find out if there is another bot in need of assistance. If help is required, the “work completed” bot goes to the work area occupied by the slower bot and assists until the task is completed. This cooperative system, or cooperabot, is extremely unique.

Finally, after all of the tasks and chores are completed, the bots are retrieved from the workplace. This is called the collection stage. When the bots have entirely completed the assigned work, they communicate with each other confirming completion, they then use the predetermined egress paths to exit the workplace and to go to the collection zone. Once assembled they are loaded using a variety of navigation options that are similar to the loading options. A first method of loading is autonomous where the bots drive themselves into the collection vehicle. Another method is assisted navigation whereby an operator “drives” the bots with a controller of some sort. In this way the operator helps the bots avoid obstacles and assists them into the transport. Finally, they could use a semi-autonomous system where it is a mixture of manual, mixed manual (for example, to avoid a wall), autonomous, or path planning. Any combination of navigation is possible. Using one of these three preferred systems the bots wait for the human operator or autonomous vehicle to arrive and signals them to load in a sequential fashion into a transport vehicle, whereafter they are taken directly to the next work field or station or are returned to the bot storage facility for repair or maintenance.

The above reservation system is the starting point for the customer use of the outdoor utility and agricultural task system using lightweight self-charging robots. Next, the actual robots and robot system is described.

### Robot System

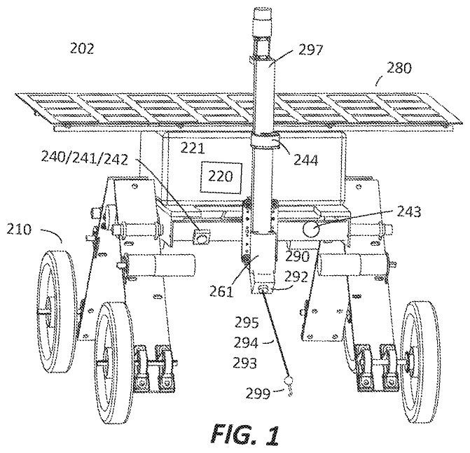

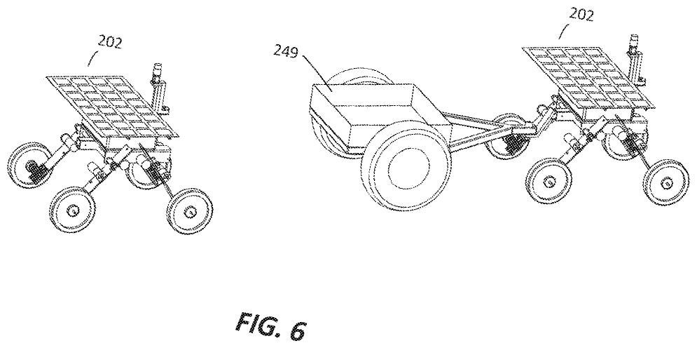

In all of the preferred embodiment there is an autonomous robot system that at its core has an autonomous ground utility robot unit, or GURU, as shown in FIG. 1. This system includes at least the above described reservations system and at least one GURU. This system also includes a computer program that allows the GURU to navigate in either a structured or unstructured environments of varying terrain. The GURU of this system, more clearly defined below, has at least a chassis, onboard sensors, a mobility apparatus, payloads, and/or attachments, or as in the present invention, implements. The attachments can be any of a variety of attachments. Some are designed for snow removal or for moving dirt and debris. Some could also be a trailer or some other apparatus to pull behind the GURU and are connected to a trailer hitch, as shown in FIG. 6. In addition to the attachments the GURU may have a payload receiving system. The payload systems include a payload receiving apparatus and a payload. The payloads are designed to perform a variety of tasks. Some are designed to suppress weeds, others are designed to control pests, other for harvesting crops but all are designed to be received into the payload receiving apparatus or by attachment to the GURU and the PTO system. By way of example the payload could be an energy beam control system, designed to suppress weeds or pests with an energy beam. To perform these tasks the GURU utilizes at least one onboard sensor that is controlled by the onboard software and onboard electronics stored in an electronics enclosure. In addition, the system may have a fueling port with fueling connectors incorporated into the GURU. The fueling port may also have a backup refueling port battery. In order to power the mobility apparatus there is a rechargeable battery powered by a solar array on the GURU. It may be also possible for the GURU to recharge at a fueling port and it may also be possible to recharge at the fueling port via an inductive charging port through inductive charging plates located on a bottom of the GURU.

### Cooperative Robots

The GURU can also act as cooperative robot, working with and in conjunction with another GURU. When the GURUs act as cooperative robots, they can interconnect with other GURUs. This cooperative functioning has several advantages. First, connecting to other GURUs provides more moving power to the first GURU or allows one GURU to move, assist or relocate a disabled GURU. Next, the robots communicate with each other and if one GURU fails or becomes disabled or stuck, then it will communicate its predicament or problem to the other available GURUs. They will then select the closest GURU to come and assist the disabled or needing robot. This might mean that the assisting GURU may take over the function or task of the original GURU. Or, it may mean that the assisting GURU comes and provides additional power or resources to perform a function, such as pushing or pulling a stuck GURU or providing additional power to move a load or even to help the first GURU catch up with the work assignment. This ability to link together allows the GURUs to work as a team. Using an autonomous navigation system to locate each other they can form a train, attaching securely front to back, using an electromechanical mechanism, or electromagnetic latch. This allows three robots the ability to pull nearly 3× the load over what a single GURU can pull.

### Human Assisted Machine Learning

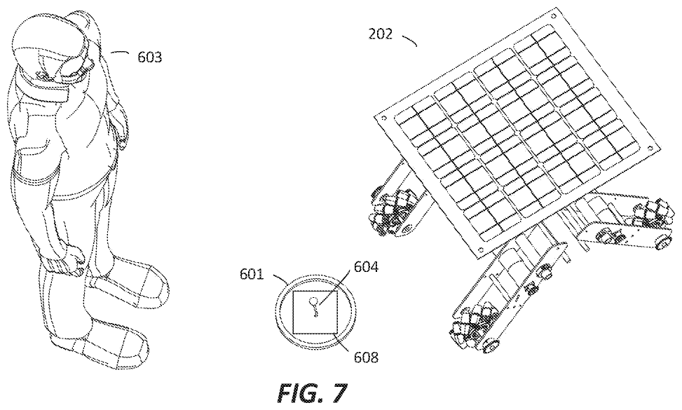

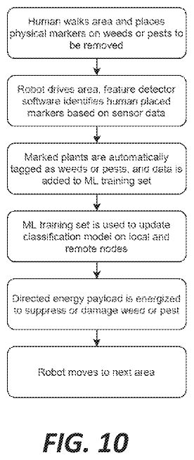

As shown in FIG. 7, another unique aspect of the present invention is a method of human assisted machine learning. This will be defined more fully later, but in general, the system includes having a human deploy a marker over a subject to be identified, having the GURU locate the marker, identify the subject and then enter the information into a data bank. FIG. 10 is a flow-chart defining and setting out the procedures and steps followed to complete the process.

GURU. To more clearly and specifically define the invention, the figures and details of the invention will now be described. FIG. 1 shows a first embodiment of a Ground Utility Robot Unit, or GURU. The work horse of the robot system is the Ground Utility Robot Unit, or GURU. One preferred design for the Ground utility robot consists of: a rectangular metal/wood chassis having at least one and preferably two identical motors placed on opposing sides of the chassis; a mobility apparatus, preferably a caterpillar track system having sprockets and chains attached to the motors; tracks around the sprockets (similar to earth moving vehicle or caterpillar); onboard sensors and onboard electronics that provide autonomous and remote-control navigation; onboard software and computer processor, an onboard solar array and an onboard fuel cell; a trailer hitch and a payload receiving system.

It is to be understood that these specifics are not limiting and that the GURU could use other similar parts to accomplish the same end result. It is also to be understood that not all of the above referenced parts are required for operation and that removal of some will not destroy the usability of the GURU. For example, the motors are preferably 2 HP electric motors but they could be different sized motors. Ideally the motors will be powered by solar arrays, such as a 200 W solar array or smaller arrays, such as the 2 W arrays. They could alternatively be powered by other means, such as propane, methane, gasoline, diesel or another alternative energy source. The GURUs could also run on a combination of fuel or energy sources. The means to power the GURU is only limited by the existing technology.

The chassis, as shown in FIG. 1, is preferably manufactured from recycled materials or easily recycled materials that are environmentally friendly. However, any material could be utilized to create the chassis, such as metal, plastics, carbon, graphite, bamboo, rubber or any other material that will accomplish chassis construction. The chassis could be a combination of materials. The chassis as shown in FIG. 1 will also have an 18-inch ground clearance, but again it could be any clearance as long as the robot is able to accomplish its tasks. The chassis must also be capable of side to side and up and down movement in order to position certain payloads, such as an energy beam control system payload. It could also have the trailer hitch, either standard or custom, for securing and pulling accessories, such as a trailer, or to link together with other GURU to utilize the cooperative GURU function as described above.

The mobility apparatus could have a caterpillar track system having tracks that rotate around wheels; however, any type of apparatus or system that allows the GURU to move about varied terrain is acceptable. FIG. 1 shows that this mobility apparatus could include any type of wheels, including: inflated or hard rubber, flat free tires, as shown in FIG. 1, or other material. Another variation could be any rotational wheel type apparatus with prongs to aerate the soil or virtually any other rotational apparatus to move the GURU around. Obviously, the easiest and most accessible apparatus would be wheels of some sort, but it should be understood that other means may be used.

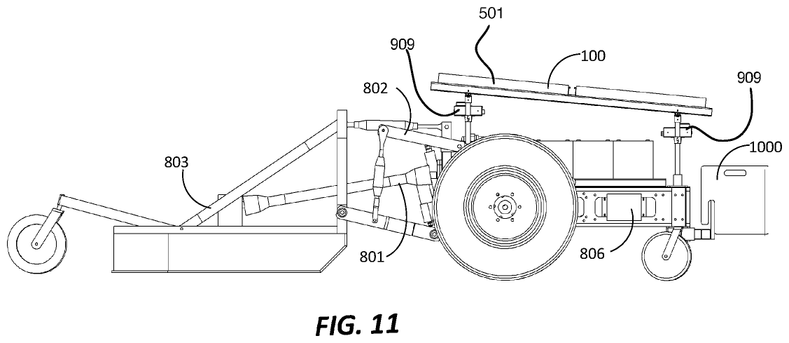

In another embodiment, seen in FIGS. 11-14, the GURU has larger rear wheels and smaller first end wheels. In this version the first end wheels are there for balance and almost float as the entire device can be controlled and turned via the larger second end wheels as they each move independent of the other, allowing one wheel to stop and the other wheel to move, thus allowing the GURU to basically turn around while remaining in one spot. When this configuration is used with the PTO it is preferable to have a first end counterweight in place if the implement is attached to the second end of the GURU.

In yet another embodiment the mobility apparatus could be a multi legged configuration similar to hexapod robots. In this embodiment the GURU is moved around by legs and the GURU is an insectoid device having the legs that navigate and move the device around. In addition, the legs would allow the GURU to climb steps or navigate rocks or other obstacles that a wheeled device could not get around. The legs would also allow the device to infinitely adjust the chassis position. And although it may be more difficult to program and control it would make the GURU lighter as there would no longer be the need to have a complicated pivoted suspension system or the linkage chassis. The legs would simply align the energy payload rather than the pivoted suspension and linkage chassis.

These bots, for all their simplicity, have sophisticated electronics and thus the bots are weatherproof and have parts that are waterproof, such as an electronics enclosure that is weatherproof as it contains the electronics, batteries and sensitive components. This is essential for the desired continual 24/7 duty cycle expected of the unit. It is also essential to preserve recorded data and to ensure that the bot is operational at all times. The bots ideally have a variety of sensors and the electronics included, among other things, allow the bots to be Wi-Fi hot spots so that no internet connection is required. The bots are autonomous. They have distance ranging sensors (as in an ultrasonic sonar, laser range finder, or LIDAR, and continual programming throughout the day and night to assist the bots with obstacle avoidance, no matter the time of day or what the weather conditions. They have motion sensors, such as cameras for motion sensing, real time viewing, telemetry and for debugging. Ideally, they will have at least one and preferably two or more cameras for depth of field vision and to cover more area and to collect more data. They could have infrared cameras as well so they can have night vision. They should have microphones to record data and to hear things, such as predators or invaders. They might have LED high powered flashlights or other lighting to assist with video, image capture, or to act as a deterrent and to scare off predators, invaders, thieves, etc. They could also have an audible device such as sirens, bells or whistles, again to send warnings, alert the customer, or to deter predators and thieves. They will have a GPS system to assist in their mobility and location. Finally, they may be able to sense air and soil conditions through a variety of ground and air sensors so that the GURU is able to record and store temperature, humidity, altitude, wind speed, velocity and direction and any other parameters set out by the customer.

Ideally the GURU is indestructible, but obviously that is virtually impossible. So, as an alternative, the GURU will at least have the following characteristics. The bot is light and easy to move around. This is so it can easily be loaded and unloaded at jobs and is easy to move around for repair. The bot is resistant to wear and tear through vibration and abuse in the field and is able to operate in all temperatures and in all weather conditions. Constantly moving through fields, even at a slow pace, takes a toll on the bot, so it must be able to withstand the abuse, as the bot should last at least 5 years. It is modular so that if a part fails it can be quickly and easily replaced with a duplicate part. This modularity is also part of the plan to have multiple robots in the field and on site at one time. Thus, if one bot fails it is easy to borrow a part from a stagnant bot for replacement, at least until replacement parts are delivered to the site. As the bots are all the same it is possible to interchange parts quickly and easily. Thus, it is clear that there are a number of variations to the preferred embodiments and so these embodiments are not meant to limit the invention.

The GURU runs entirely on solar power in the preferred embodiment. However, there may also be an onboard fuel cell to compliment and support the onboard solar array. If an onboard fuel cell is included, then the onboard fuel cell will recharge itself mainly using the onboard solar array but if needed the system may include refueling at a fueling docking port. This docking port could be connected to the grid but could also have a large capacity fueling port battery along with its own on-site solar array so that the battery can be recharged using only the on-site solar array. In addition to or in place of the on-site solar array the system could be powered by other alternative fuels. These alternative fuel sources could include but are not limited to methane, hydro, latent ground heat, thermal or wind and fuel cells.

The GURU will automatically know when it needs to recharge based on programming that takes into account data including but not limited to its current charge level, its distance from the fueling port, and the amount of time and obstacles required to pass to return to the fueling port. Once this is calculated the GURU will self-navigate and return to the refueling fueling port to automatically refuel. Once at the fueling port the GURU will recharge either by docking into a fixed port via the fueling port connectors on the GURU or by utilizing an inductive charging port using a charging plate on a bottom of the GURU.

It is also important that these GURU have the ability to navigate in both structured and unstructured environments. A general aspect shared between all GURU is autonomous navigation in an unstructured, dynamic environment, with or without the use of GPS. The GURU are taught a logical “graph” of the locations and paths between them, then use that pre-learned topological graph to navigate, using real time localization from all available sensors. Also, the GURU can operate in a geo fenced area or a learned route (visual learning or using a set of GPS coordinates) that will teach the GURU so that it can avoid any obstacles by either stopping or taking evasive action. Onboard sensors, such as cameras, provide data for autonomous navigation and for remote telemetry/capture/real time monitoring. The GURU will use a navigation pattern suitable to the terrain and task: in a flat, unstructured hay farm, or grass lawn, the GURU will use a spiral pattern, picking a center, then starting on the perimeter of the geo-fenced area, and decrease the radius as it rotates around the “virtual center” of the task area. This minimizes abrupt turns, saving energy, and allows the GURU to exit, from the center of the area using a direct path to the exit point. The spiral pattern is achieved by moving the virtual GPS markers closer to the center, after each rotation, forcing the GURU to navigate an increasingly smaller area, again in a circular pattern.

The GURU also features artificial intelligence with an ability to learn as it works. One way to teach the GURU navigational skills is through training. In this scenario a user uses a training procedure whereby the GURU is moved around a specified area. For example, it could use a two-node training system where the user assigns a point A and a point B and where the GURU then navigates between points A and B. While navigating between these two points the GURU will collect data and information using the onboard sensors, such as location sensors (GPS), inertial sensors, magnetic field sensors, microphones and cameras, and will apply this collected data to learn from this information.

Alternatively, the GURU could be trained using geofencing and virtual GPS markers. In this scenario the user supplies a predefined graphical area in which the GURU is allowed to roam. This area can be created from GPS coordinates, for example or even from Google® maps. The area is defined using virtual coordinate markers, which appear as obstacles in a 360-degree obstacle profile. The virtual obstacles and the real obstacles (detected through onboard sensors such as LiDAR, sonar, infrared emitters) are fused into a single obstacle depth profile, used by an autonomous navigation software. Once this area is defined by the user the GURU is allowed to freely roam around the predefined area. As it roams this area it again will use onboard sensors, microphones, cameras, etc. to collect data from which it will learn.

The bots can perform a variety of tasks and will be extremely useful to the consumer, customer or user. It is envisioned that the bots be affordable, resilient, low maintenance, autonomous and environmentally friendly. Specifically, it is envisioned that the bots cost approximately $5,000 or less. That they have a duty cycle duration of approximately in 75% active and 25% low power mode, with the ability to charge while performing a task (through solar). Minimum runtime is expected to be 6 hours. As low maintenance devices it is contemplated that they will only require maintenance or service less than once a year (for repair or replacement parts). The fuel source should be environmentally friendly and preferably off the grid. To that end electricity will come from solar or grid tied base (docking) station, docking port, which could also have the large battery pack that is solar powered via the on-site solar array. Alternatively, the methane system could be used where the methane is collected from the user's livestock, stored and distributed to the user and other users in the near vicinity. The refueling for the bots will take place at the autonomous docking port whereby the bots automatically returns to the docking port when it is in need of refueling. And finally, the bot system has a limited environmental footprint. As such it is envisioned that more than 90% of the materials used for the bots will be from recycled materials plus renewable materials by weight. This will create a net negative climate warming print through the removal of potent greenhouse gases.

Software. The above robots all have an extremely intelligent software system built into them and into the control company and this software is also an integral part of the invention. The platform is also quite sophisticated. It includes self-update capability (self-update task service), secure (simple RBAC AuthZ model: admin, automation, local user), telemetry to cloud, (if internet access is available), local persistence of configuration and sensor data and actuator commands. It also features great autonomy. Some of the features include: localization using depth profile, GPS, Wi-Fi signal strengths; navigation using topological path planner (which relies on localization); real time obstacle avoidance with signal conditioned input from 2D LiDAR, sonar, vision; IMU inertial drive controller (tilt, collision); feature detector, feature matcher services; IMU, temperature, etc. sensor services; and weed and pest classification using machine learning algorithms. The software covers not only the entire reservation system as described above, but also systems that provide: obstacle avoidance, autonomous docking, autonomous refueling that includes locating the docking port when fuel is low and connecting with the fuel source while docking (either through a plug in attachment or through inductive charging system, user guided topological learning tasks, that is, learning the logical graph of locations where the GURU will operate, virtual GPS markers restricting movement in a pre-defined area, marking obstacles or hazards to navigation, autonomous or semi-autonomous navigation using a learned topology map or global positioning coordinates, telemetry publish to stream ingestion compute nodes (in remote data centers, and to local peer robots), update of learned tasks from offline training, downloaded/synchronized from remote nodes, fleet management code and self-update of all code and configuration (part of common control company software platform), anomaly detection and peer monitoring software that enables robots to take over tasks for a robot that has failed performing its task, within predefined time and space parameters, and leader election software algorithm that enables one healthy robot, from a deployed group, to take over the task for a failed robot.

### Human Assisted Machine Learning and Real Time Subject Identification

In addition to the reservation software, the operational software and the bot apparatus, there must be an efficient method or means to train the bots. Thus, this invention also teaches a human assisted machine learning and real time subject identification system, as shown in FIG. 7 and FIG. 10 flowchart. This system is based on a computer vision algorithm that processes camera images and identifies particular physical subjects of a specific color and pattern on their surface, such as weeds/non-weeds. This machine learning uses human assistance to facilitate learning. The system is relatively simple but is quite unique. To start, a human will take a physical marker and places it over a subject. Ideally the marker is an open ring, an open box, or any other configuration that has an open center and creates a perimeter around the subject. The human will take the marker ring and place it around the subject to be identified. Once the physical marker is placed on or around the subject the onboard camera captures an image or images of the subject to be identified. Next, the robot software system/onboard software system, uses image processing through a programmed image processing algorithm, to detect the subject's visual signature in real time images. If the physical marker is identified in the current marker image, then the enclosed image area is cropped, edited, labeled and stored as a separate, final image for future machine learning training tasks.

This system works to very quickly advance the machine learning in the beginning by utilizing large numbers of humans to assist with the identification process. For example, each customer could be given some sort of incentive to assist in the program. After accepting the incentive, each customer would be responsible for placing maybe 500 markers on weeds. As an example, if the system rolls out and has 500 customers and all customers agree to participate in the incentive program, and if all complete the incentive program, then the customers would input 250,000 pieces of data in the form of camera images.

This system is also designed for the GURU to work as it is taught. For example, if a marker is identified by the bot then the task assigned is also performed. So, if the task is weed suppression, and the attached physical payload on the bot is a laser the non-plant/weed is identified, and the laser is turned on and aimed at the center of the marker image region. Prior calibration allows the robot to determine the relationship between the image location and the corresponding physical location to those image pixels. Once aligned the robot performs the weed suppression action (described below) and moves on to the next marker.

The GURUs can be used for a variety of work. Their applicability and usability are virtually endless. A few examples include snow removal, dirt removal, grading, mowing, trimming, weed suppression, pest control and suppression, harvesting crops, perimeter security, weather reporting, ground/earth testing and reporting, animal surveillance and health reporting, keeping stray animal and predators away from local livestock and off the property, security services such as reporting intruders and trespassers, use of non-lethal means to repel intruders, follow along functions, debris removal and cargo movement, ground aeration, and any of a variety of other chores and duties. Below are some more detailed explanations of some of the uses and embodiments of the present autonomous robot system.

### Implement Attachment Apparatus and Power Take-Off

The present invention and claim set deals specifically with FIGS. 11 through 18, using the GURU 100 described above to power, drive, control, operate and run a power-take-off (PTO) and to the system and software required to assign, control and manage the tasks assigned to each GURU. PTO is a term used to describe the process of transmitting power from one point to another. A PTO shaft is a cylindrical metal rod that attaches to a power source, such as a tractor, or in the present invention, the GURU, at one end and an attachment or implement, such as a mower, at the other. With a conventional PTO, when the tractor's engine is running, power flows along the shaft. The shaft rotates at engine speed, transferring energy from the engine to the attachment. In the present invention, however, the GURU provides the power rather than the tractor engine. The present invention uses one or more independent electrical motors and control logic to power and control the PTO system. These motors, along with drive wheel motors, run off an onboard power supply, such as a battery, that is recharged typically with solar power. It should be understood however that it is not limited to solar but rather, this is the preferred method of recharging as it is most environmentally sound.

PTOs are extremely valuable to farmers and others in a wide variety of industries. For example, PTOs can be used for soil cultivation (rotators, subsoilers, strip tills); planting (trowels and seed drills); fertilizing and pest control (liquid manure/slurry spreader, dry manure spreader, sprayer); irrigation (sprinkler, spray heads); produce sorter (blemish, color, density, diameter, internal, shape or weight sorter); harvesting (conveyor belts, pickers, tree shaker, mower, rake, reaper, rice huller, swather, grain hopper); hay making (bale lifter, bale wrapper, baler, hay raker); loading (tractor mounted forklift, skid-steer loader); animal feeding (grinder, mixer) and many other applications. A power take-off or power takeoff is any of several methods for taking power from a power source, such as a running engine, or as in the present invention, the GURU, and transmitting it to an application such as an attached implement or separate machines. Most commonly, it is a splined drive shaft installed on a tractor or truck allowing implements with mating fittings to be powered directly by the engine. Again, in the present invention, this power is provided by the GURU. Semi-permanently mounted power take-offs can also be found on industrial and marine engines. These applications typically use a drive shaft and bolted joint to transmit power to a secondary implement or accessory. In the case of a marine application, such shafts may be used to power fire pumps. In all applications of the present invention the power is provided by the GURU.

Most PTOs use the gear train to drive the PTO. Inside the transmission, the exact point along the gear train where the power is taken off determines whether the PTO can be run independently of vehicle travel (ground speed). Early PTOs were often taken off the main output shaft, meaning that a vehicle had to be “in gear” in order to run the PTO. Later this was improved by so-called live PTO (LPTO) designs, which allow control of the PTO rotation independently of the tractor motion. This is an advantage when the load driven by the PTO requires the tractor motion to slow or stop running to allow the PTO driven equipment to catch up. It also allows operations where the tractor remains parked, such as silo-filling or unloading a manure spreader to a pile or lagoon rather than across a field. In 1945, Cockshutt Farm Equipment Ltd of Brantford, Ontario, Canada, introduced the Cockshutt Model 30 tractor with LPTO. The PTO in the present invention is live. In modern tractors, LPTO is often controlled by push-button or selector switch. This increases safety of operators who need to get close to the PTO shaft. The present invention increases safety by having the operation performed by the GURU, assistance supplied by other GURU and only programming performed by humans on a routine basis. Obviously, there may be times when human assistance is required, but it is minimal compared to a traditional implement and PTO device and therefore is much safer.

The PTO and its associated shafts and universal joints are a common cause of incidents and injury in farming and industry. According to the National Safety Council, 6 percent of tractor related fatalities in 1997 in the United States involved the PTO. Incidents can occur when loose clothing is pulled into the shaft, often resulting in bone fractures, loss of limb, or death to its wearer. Protruding pins and bolts used as connection locking devices are particularly adept at snagging clothing. If clothing doesn't tear or rip away, as it sometimes does for the fortunate, a person's limb or body may begin to wrap with the clothing. Even when wrapping doesn't occur, the affected part may become compressed so tightly by the clothing and shaft that the person is trapped against the shaft. One of the goals of the present invention is to minimize this risk and to provide a safer PTO to the user.

This risk minimization is performed and accomplished using a variety of components of the present invention. First, sensors in a motor control logic detect the current draw of the PTO motors and based on user defined settings can shut off power if limits are exceeded. Thus, if a human body part, or large obstacle is being pulled into the system then the system will automatically shut down. Next, the obstacle and motion detection sensors 909, mounted either on the GURU, on the implement, or on both, are used to disable the PTO by cutting power to the GURU, the PTO, or both, if a moving or stationary object comes within a predefined distance from the PTO attach point. Different shapes described visually (as trained images), thermally (as heat profiles from a thermal camera) or shaped in 2D or 3D in a configuration file can be used to identify humans versus other objects, are used together to create an efficient and sophisticated PTO safety system, capable of operating with minimal false negatives and much increased safety.

In a typical PTO, the machine's shaft is coupled to the tractor's PTO stub and rotates at either 540 rpm (9 times/sec.) or 1,000 rpm (16.6 times/sec.) when at full recommended speed. At these speeds, clothing is pulled around the shaft much quicker than a person can pull back or take evasive action. Many shaft entanglements happen while the shaft is turning at one-half or one-quarter of recommended operating speed. This may be the situation on occasions when the tractor has been stopped but not turned off, and the PTO is left engaged. The point is that even at slower speeds, once caught by a shaft, a person may not have time for evasive action. A 540 rpm shaft makes over two complete revolutions per second when operating at one-quarter speed. Even with a relatively quick reaction time of five-tenths of a second, the wrapping action has begun. Once wrapping begins, the person instinctively tries to pull away. This action simply results in a tighter, more binding wrap. The 1,000 rpm shaft roughly cuts in half the opportunity for evasive action.

PTO powered machinery is engaged while no one is on the tractor for many reasons. Some PTO powered farm equipment is operated in a stationary position: it needs no operator except to start and stop the equipment. Examples are elevators, grain augers, and silage blowers. At other times, adjustments or malfunctions of machine components can only be made or found while the machine is operating. Additionally, many work practices such as clearing crop plugs leads to operator exposure to operating PTO shafts. Other unsafe practices include mounting, dismounting, reaching for control levers from the rear of the tractor, and stepping across the shaft instead of walking around the machinery. An extra rider while PTO powered machinery is operating is another exposure situation.

The wrapping hazard is not the only hazard associated with shafts. Serious injury has occurred when shafts have become separated while the tractors PTO was engaged. In some embodiments, the machine's shaft is a telescoping shaft. That is, one part of the shaft will slide into a second part. This shaft feature provides a sliding sleeve which greatly eases the hitching of PTO powered machines to tractors and allows telescoping when turning or moving over uneven ground. If a shaft is coupled to the tractor's PTO stub but no other hitch is made between the tractor and the machine, then the tractor may pull the shaft apart. If the PTO is engaged, the shaft on the tractor end will swing wildly and may strike anyone in range. The swinging force may break a locking pin allowing the shaft to become a flying missile, or it may strike and break something that is attached or mounted on the rear of the tractor. Separation of the driveline shaft is not a commonly occurring event. It is most likely to happen when three-point hitched equipment is improperly mounted or aligned, or when the hitch between the tractor and the attached machine breaks or accidentally uncouples.

Through the use of the present invention injury risk is greatly reduced. A large number of accidents involves an operator. By removing the operator from the equation, the chance of injury is greatly reduced, in fact, removed. With the operator removed from the equation the only time injury could occur is when the GURU or implement require maintenance and repair. In the present invention this is typically overseen by professional operators and possibly other bots. For example, if an implement becomes inoperable, due to such as a clog for example, in an auger, it could be possible to program an accompanying or follow-up bot to clear the jam, thereby removing the hazard from human contact. In addition, the present invention has a variety of safety systems built in, including the sensor and control logic described above, that will completely stop the PTO shaft if a person or other object is detected near the PTO. Overall, the present invention includes a plethora of additional safety measures that will reduce the amount of human interaction required and thus will reduce the number of accidents.

Furthermore, the present invention removes the use of polluting internal combustion engines for powering the PTO and uses stored electrical energy instead, supplied by solar and the GURU batteries. The batteries can be recharged by renewable means, such as the solar panels attached to the GURU, methane fuel cells using locally captured methane from plant and animal emissions, or grid power. In addition, electrical motors are simpler, are easier to repair and are easier to scale up in power by simply adding motors using the invention's custom gearbox. Field repair is also simplified as the customer can easily replace a damaged motor or gearbox without help from the control company supplying the PTO/GURU.

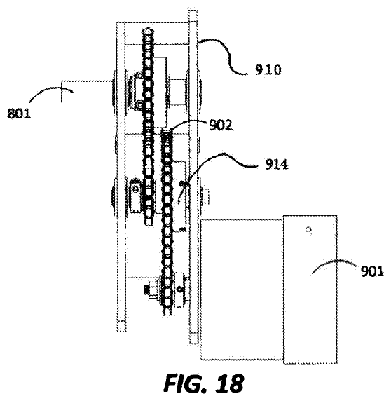

It is because of the current problems in the existing technology that the present invention was created. In general, this invention is a powered implement system having a ground utility robot, at least one three-point hitch, a means to connect the at least one three-point hitch to at least one end of the ground utility robot, at least one power take-off on the ground utility robot that is connectable to at least one implement, and where the ground utility robot powers the at least one power take-off as shown in FIGS. 11-17. More specifically, this invention is an implement attachment apparatus for use with and attachment to a ground utility robot 100 having a three-point hitch frame 802 with at least one lower lift arm 903, at least one adjustable leveling arm 905, at least one top link 904 and at least one support arm 908 where the three-point hitch frame is connected to the ground utility robot 100. A power take-off system is connected between the ground utility robot and the implement and the power take-off system has an electric linear actuator 906, a power supply 806, such as a fuel cell or, as in one embodiment, a battery that is charged and powered via at least one solar panel located on the ground utility robot. There is also another assembly having a gearbox assembly 902 as shown in FIG. 18 where the gearbox assembly has a first side connectable to the at least one motor assembly 901, where the motor assembly 901 is connected to the power supply 806 so that the power supply 806 powers the motor assembly 901. The second side of the gearbox assembly 902 has a power take-off shaft 801 that extends outwardly from the gearbox assembly in the direction of the implement and where the power take-off shaft 801 is connectable to the implement.

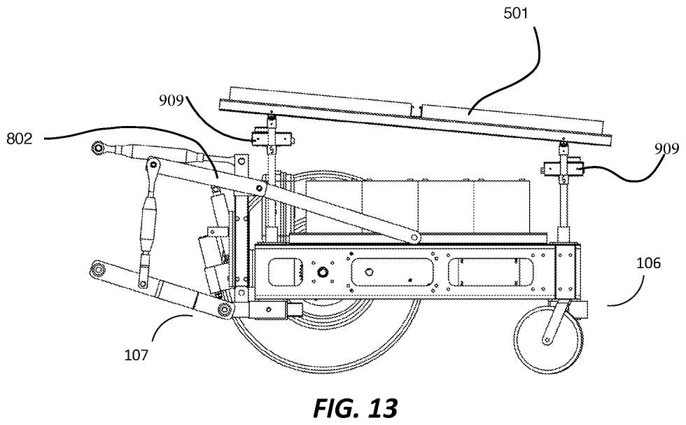

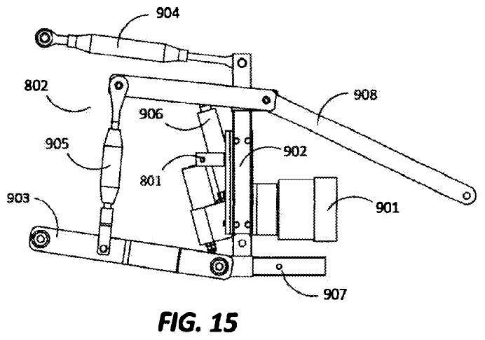

In addition, the implement attachment apparatus ideally has the gearbox assembly 902 and the motor assembly 901 securely affixed to the three-point hitch frame 802, as shown in FIG. 15. Further, it is preferable to have the three-point hitch frame 802 securely affixed to the ground utility robot 100. This can be done by inserting a shank 907 into a mating receiver on the ground utility robot 100. However, it is not limited to this type of attachment. Any other type of attachment can also be utilized so long as the implement is securely attached to the GURU. Next, the support arm 908 is securely affixed to both the implement and to the GURU to stabilize and solidly connect the two units, as shown in FIG. 13. The power take-off shaft first end 804 is then matingly connected to the gearbox assembly 902 via power take off shaft 801. The gearbox assembly 902 is in turn connected via motor shaft 915 to the motor assembly 901. The motor assembly 901 is connected to power supply 806 that is located on the ground utility robot 100 where the power supply 806 is powered by the solar panels located on the ground utility robot. The power supply in a preferred embodiment is a battery but can be any type of apparatus that will drive the system, including a gas engine, diesel engine, fuel cell or any other apparatus or device that can provide power to the implement. The power supply 806 is ideally connected via a cable that receives power from the solar panels on the GURU, to the power supply 806, to the motor assembly 901, to the power take off shaft 801, and then finally to the implement.

As noted above, security and safety are huge issues when it comes to operation of the PTO. The present invention has numerous means in place to assure safety and to prevent accidents. First, the present invention virtually removes humans from the equation. The GURU is controlled via a computer system that is overseen and controlled by the service company. Thus, the implement, when attached, is also controlled by the computer that can either be onboard or offsite, and the control company via programming. It is noted that although the computer can be on the robot, it may be located off the robot at a remote site. If this is the case the robot will be controlled remotely. The programming for the unit also has safety protocol programmed into the system. As seen in FIGS. 11-14, the GURU 100 already has a variety of sensors 909 onboard, including motion detectors, cameras, infrared cameras, heat detection sensors, sensors in a motor control logic and others as described above. These sensors are positioned at different locations on the ground utility robot, on the implement attachment apparatus or both and these sensors 909 work together to sense abnormalities and if an abnormality is sensed then a signal is conveyed to the computer so that the system will know when to stop or when and how to avoid objects. They also work together to establish and identify a living or non-living thing. The at least one sensor 909 on the ground utility robot that senses objects and the safety program utilize a processing logic on the computer whereby the safety program begins evasive or precautionary measures if an object is detected that the processing logic deems hazardous. This system can detect large logs, ravines, rocks, un-navigable terrain, and other hazards, but more importantly it can detect animals and humans. Using the cameras, motion detection and infra-red, the system knows if there is a living being in its path and when the living being is sensed the system takes action to either avoid the being or it shuts down the PTO altogether to avoid any injury or accident from occurrence. In operation, the system might shut down the GURU, it might shut down the PTO, or it might shut down both, depending on what is sensed and evaluated by the system. This is a huge advantage over the existing technology.

Furthermore, if an implement becomes jammed or clogged it is possible for another GURU to come to its aid and either remove the clog or jam, or assist in finishing the job, or push the other GURU out of the path so that other GURU may complete the task. This cooperative system is also highly unique and is described in more detail in other sections of the specification.

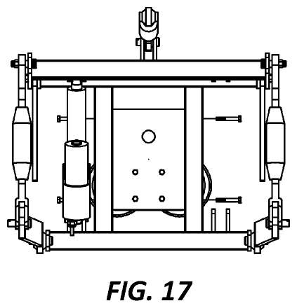

This invention is also highly adaptable and versatile as it is attachable to either end of the GURU 100. FIG. 11 is a side view of the GURU 100 of the present invention with a common type mower deck 803 attached to a back end, or second end 107 of the GURU 100 unit and driven by the PTO 800 and a counterweight 1000 is affixed to a front end, or first end 106 of the GURU 100. In this embodiment the GURU has larger wheels located at the second end 107 of the GURU 100. Technically, the GURU 100 does not truly have a front or a back as it can be operated in either direction. For clarity sake with respect to the descriptions herein, the GURU has the first end 106 and the second end 107. In FIG. 11 the counterweight is seen affixed to the first end 106 of the GURU in order to balance the GURU from the added weight of the implement. This counterweight does not have to simply be dead weight as it could be an additional battery or multiple batteries that are attached to the first end and also act as counterweights. This is preferable as in this configuration the bot has additional power and is not just pushing or pulling around dead weight. FIG. 11 shows the implement/mower deck connected via the three-point hitch 802 to the second end 107. The three-point hitch 802 can be connected directly to the GURU via a variety of attachment means, but in a very simplistic and convenient connection it uses a standard receiver hitch. In this embodiment the three-point hitch 802 has the shank 907 that is inserted into a common receiver and that is then fastened therein using a pin or some sort of connector. When connected to the second end 107 of the GURU 100 the implement 803, here a common mower deck, adds substantial weight to the GURU 100 and as noted above, the counterweight 1000, such as an additional battery or more, may be required at the first end 106 of the GURU. The motor assembly can also be seen in this image. Motor assembly 901 is responsible for controlling the amount of power supplied to the PTO 101. In order to provide even more power to the system it is also possible to have more than one motor assembly. FIG. 17 shows another configuration having two motor assemblies.

The power take-off shaft 801 of the PTO 800 is seen in FIG. 11 and FIG. 18. The power take-off shaft 801 has the first end 804 that connects directly to the gearbox assembly 902 as shown in FIGS. 11, 12 and 18. The PTO typically includes a yoke, a cross and bearing kit, a shaft yoke, the shaft, a tube weld yoke, another cross and bearing kit, and an implement yoke to attach whatever implement is desired. These are somewhat standard parts and many different PTO can have differing parts depending on the internal configuration. Although important, for the present invention the most import thing is that there is a workable PTO that is connectable to the GURU. In FIG. 11, the shaft second end 805 is seen as connected to the mower deck/implement 803.

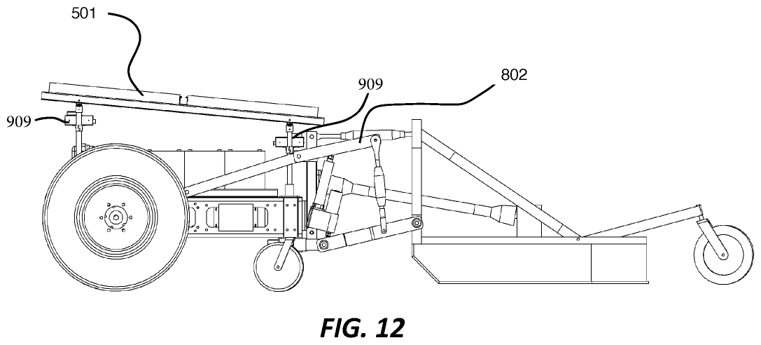

FIG. 12 is a side view of the GURU 100 with the common mower deck 803 attached to the first end 106 of the GURU 100 unit and driven by the PTO 800. In this configuration there is no need for the first end counterweight 1000 as the weight of the mower deck 803 keeps the units balanced. It is also possible to have implements positioned at both the first end 106 and second end 107 of the GURU 100 simultaneously. For example, it could be possible to have the mower deck 803 affixed to the first end that cuts grass and then have a collecting implement connected to the second end 107 of the GURU 100 to collect the grass clippings. Obviously, any number of cooperative implements could be affixed to the first end 106 and the second end 107 of the GURU 100 to work in unison.

FIG. 13 is another side view of the present invention with the three-point hitch 802 attached to the GURU. Support arm 908 is clearly seen in this figure when attached to the GURU. This figure shows the parts of the three-point hitch as connected to the GURU but prior to any implement attachment.

As seen in FIGS. 11-14, the GURU typically has a solar array 501 mounted on the top of the unit. As noted above, the GURU can run predominantly off the solar array 501. In fact, in the current embodiment, both the GURU and the PTO run off the onboard battery and the solar array 501. As noted, additional batteries may be used as the counterweights that would provide additional power to the system.

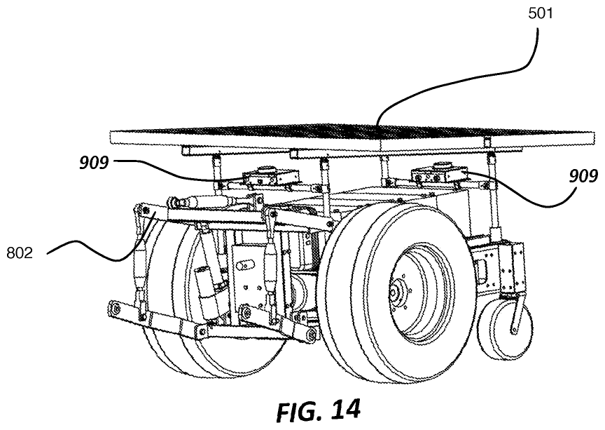

FIG. 14 is a perspective view of the present invention with the three-point hitch 802 affixed to the GURU and prior to implement attachment. Sensors 909 are seen as is solar panel 501. In this embodiment a single motor assembly 901 can be seen affixed to the three-point hitch 802. The electrical motor attached to the PTO output shaft using a custom design gearbox that reduces the motor revolutions per minute (RPM) by a constant factor. The custom gearbox comes in versions that support a single, or multiple motors, driving the same single output shaft. The motors are controlled via an electronic circuit called a motor controller, which receives signals from a computing device mounted on the GURU, or on the PTO assembly itself, which can be networked with computers in the local robot or other remote locations.

FIG. 15 is a side view of the present invention with the three-point hitch system 802 by itself. Here, the single motor assembly 901 and gear box assembly 902 are connected directly to the three-point hitch 802 and are directly above the shank 907. Support arms 908 help transfer the load placed on the hitch system into the GURU's main frame. The electric linear actuator 906 is used to raise and lower the lift arms and by extension the attached implement. The lower lift arms are connected to the lift actuator 906 via the adjustable leveling arms 905. The top link 904 and the two lower lift arms 903 provide the attachment points to secure the implement to the three-point hitch 802.

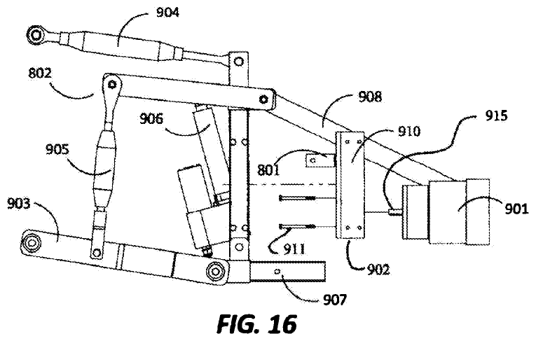

FIG. 16 is an exploded side view of the three-point hitch 802 showing the gearbox assembly 902. The gearbox assembly 902 includes an encasement 910, connecting members 911 to secure the gearbox assembly 902 to the three-point hitch, at least one power take-off shaft 801, and internal gearing mechanism 914, more clearly shown in FIG. 18. Also shown in FIGS. 16-18 is the motor assembly. This is generally an electric motor and in the present invention it can be one or more motors, depending on the requirements of the implement. As can be seen in FIG. 16, the motor has a shaft 915 that is inserted into the gearbox assembly encasement 910 whereafter it engages the internal gearing mechanism 914. The internal gearing mechanism 914 then transfer the power to the at least one power take-off shaft 801 that is then connected to the PTO shaft that then drives the implement.

FIG. 17 is a rear view of the three-point hitch 802 showing the dual motor assembly 901 configuration. Using the dual motor configuration, the PTO power is doubled but the assembly remains simple, still using a single output shaft and a single gear reduction box.

The above described apparatus uses the active safety system to provide a safe environment for users and others around the system. It can do this in a number of ways. Specifically, it provides a method of hazard avoidance by the ground utility robot and the implement having the steps of providing a ground utility robot, a computer, at least one implement, at least one solar panel, at least one battery, at least one power take-off, and an operating and controlling program installed on said computer, connecting the at least one power take-off to the ground utility robot, connecting the at least one implement to the at least one power take-off, charging the at least one battery by the at least one solar panel, powering the ground utility robot, the at least one power take-off and the at least one implement with the at least one battery, and having safety system being comprised of the computer, a safety program and at least one sensor, the operating and controlling the ground utility robot and the at least one power take-off using the operating and controlling program. In this embodiment the ground utility robot starts operation by commencing a preassigned task. This task can is assigned by an operator and can be a new task or a preassigned task. The ground utility robot uses the at least one sensor for sensing, obtaining data and communicating that data to the computer where the computer begins processing the data on the safety program, then analyzing the data for the presence of an obstacle or no obstacle, then the system begins recognizing the obstacle. After recognizing the obstacle then the system begins initiating at least one evasive measure if the obstacle is within a predefined distance of the ground utility robot or the at least one implement where the at least one evasive measure is one or more of the following: changing the ground utility robot's directional path; cutting power to the ground utility robot; and cutting power to the at least one power take-off. This system is designed to prevent accidents through the systematic recognition of an obstacle in the predefined distance. In addition to the initial avoidance by the ground utility robot, the ground utility robot will next use the at least one sensor for ongoing monitoring of the obstacle within the predefined distance of the ground utility robot and the at least one implement where the system will begin reversing the at least one evasive measure when the obstacle is clear from the predefined distance and restarting the preassigned task. In this way, the safety system does not only prevent accidents from happening but it also continues to monitor the area so that when the area is clear the system can resume its preassigned task and will continues working towards completion of the preassigned task.

The system also continues to learn as it works. In one embodiment the system starts assigning at least one value to the obstacle where the at least one value is human, animal or thing, then storing this value as a learned value; and finally assigning a specific evasive measure based on the learned value. Over time the system eventually differentiates between animal, human, and other object. This system may also include an active monitoring system for the power take-off, where the system has at least one power take-off sensor constantly sensing and monitoring a current draw on the at least one power take-off, then setting a high-end current draw limit on the at least one power take-off and if the high-end limit is reached or exceeded then shutting down power to the at least one power take-off. This system is designed to prevent an animal or object from being pulled entirely into the power take-off. In operation, the GURU might be assigned the task of cutting grass. The system knows how much current draw is typical while cutting grass and a high limit is set for this amount of current. If the GURU encounters a tree branch or a human arm, for example, and the branch or arm creates greater resistance to the cutting blade, then the program recognizes that the current draw is higher than normal, that the high limit is breached and thus the system initiates the specific evasive measure or measures, such as cutting power to the GURU, to the PTO or both.

The system as described provides enhanced security and safety measures. It is designed to protects the apparatus from damage if it encounters large branches, rocks or other large objects. More importantly, it is designed to protect animals and humans from harm if encountered by the ground utility robot. In addition, the system continues to learn as it encounters obstacles, storing information and differentiating living from non-living, human from non-human, animal from human, just to name a few.

### Snow Removal

Another application or embodiment utilizing a GURU, is a snow removal apparatus that is added to the GURU. As noted, there are few robot applications for the typical consumer, but this is, or could be, a consumer-focused product. Thus, the target customers for this embodiment are consumers that spend significant time managing snow during the winter months. This is the vision of this embodiment; however, these bots could be used in larger format in rural areas to clear roads and highways, particularly at night when traffic is at a minimum. But for this application in particular, rural residents with drive ways, who currently use manually operated, fossil fuel powered machines, could utilize the bots for continual snow removal. Currently the technology exists to have the robots be responsive up to 0.5 miles, but with time this limitation will be removed, and the robots will have a much greater range.

In this embodiment the GURU uses a snow removal attachment apparatus that removes snow by slowly pushing the snow using a blade or other pushing apparatus of some sort. This snow blade can be a typical, off the shelf blade as the GURU can be configured to accept this type of attachment. Alternatively, the blade could be a custom blade designed specifically for use with the GURU and that more efficiently removes snow. When specifically designed, this pushing apparatus has, in addition to the blade, an orifice or opening for receiving snow. The blade can be designed so that the collected snow is slowly funneled back into the orifice through a snow funnel channel as the GURU slowly moves along its snow removal route. Once the snow is collected by the blade it is then ingested into the orifice. Behind the orifice is a melting area. In this melting area the snow contacts a heating element. This heating element is heated using excess heat from an onboard fuel cell or by some other means of creating heat. Once the snow contacts this heating element it melts, and the resultant water is then ejected and is dispersed in a predefined direction using a spraying apparatus. This removes the snow from the route and places the resultant water away from the cleared path. This entire snow removal apparatus can be connected as a singular unit to the GURU or it could be integrated with the device itself.

A key part of this invention using the snow removal apparatus is the use of the on-board fuel cell, to both power the GURU and ingest and melt snow, as described above, while moving autonomously, on a 24/7 duty cycle. In this embodiment the GURU with the snow melting capability operates continuously and self-charges, and instead of pilling the snow on the sides of the access roads, it sprays melt water in pre-programmed directions. A pump takes the melt water and sprays it away from the snow removal GURU. The melt water is directed away from the surface being cleared, a minimum of 10 feet from the GURU, towards a direction specified by the user. This massively simplifies the task of snow management, because snow placement is a large issue. By converting the snow to water, it removes the need for heavy plows, augers, or other moving parts that get stuck or frozen shut. In this embodiment a snow removal gear filters and melts the snow using the excess heat from the fuel cell reaction.

In one embodiment this snow removal apparatus is methane fueled. In this embodiment there is a methane fuel cell and a custom designed methane snow blade with a grid of pipes that circulates hot water (over 400 degrees Fahrenheit) through the pipes. There is also a water collection basin located near the rear side of the methane snow blade that collects and melts snow using excess heat from the methane fuel cell. Finally, there is a system of methane spray pipes and methane spray pumps that spray away excess melted snow water from the GURU and its path.

There can also be a battery powered variant of the snow removal device that includes all of the above features from the methane version but instead of using methane as fuel it uses a battery. The battery version also features an inductive charger plate on an underside of GURU, so that the bot can charge wirelessly via inductive charging.

The goal for autonomous snow removal is to prevent snow accumulation on roadways without human intervention. An autonomous snow removal GURU continuously removes snow when it detects snow fall. Obviously, snowfall can be detected using one or more of the onboard sensors, such as the camera or maybe a moisture sensor that senses snowflakes. The GURU is ideally battery powered and self-charges using solar power from either the onboard solar array, or magnetic inductive charging via the inductive charger plate at the base station system inductive charging port, or with the base station or fueling port. Ideally the autonomous robot system also has a separate solar array located at the fueling port that continually charges the system recharging battery.

### Follow Me Bots

Another use for the Robot system is that of cargo transportation through a “follow me” function. The same GURU, in all seasons, can perform a “follow me” function, pulling a trailer so the human owner can have the GURU follow them around, place subjects (produce, weeds, logs, heavy items) in the trailer, then instruct the GURU to “go to” a pre-learned destination. This trailer ideally is designed to work specifically with the bot but could also be a general trailer that is configured to work with the GURU or where the GURU is configured to work with the trailer.

A key part of this embodiment is that the GURU will not only follow the user, using machine vision, and/or wireless beacons, but will also autonomously navigate to pre-learned locations and “dump” the items, then return to the owner.

### Weed Bots

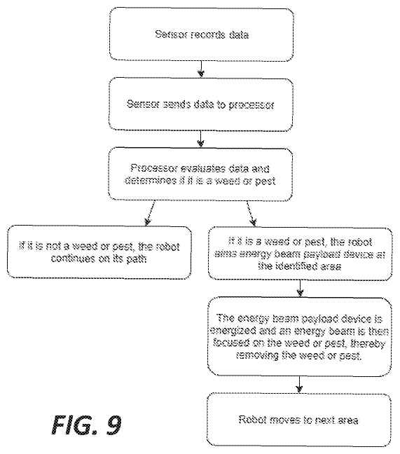

The next three embodiments of this invention involve means, apparatus and systems to control weeds, to control pests and to harvest crops. The process is shown in FIG. 9. All three embodiments utilize generally the same technology, that is, utilizing and controlling an attachment apparatus, such as a focused energy beam, or a mechanical weed drill, or a collecting apparatus, to accomplish similar tasks but with different results. In an alternative embodiment the attachment apparatus is stationary and the GUR mobile apparatus is adjustable. The first embodiment below is for the adjustable attachment apparatus.

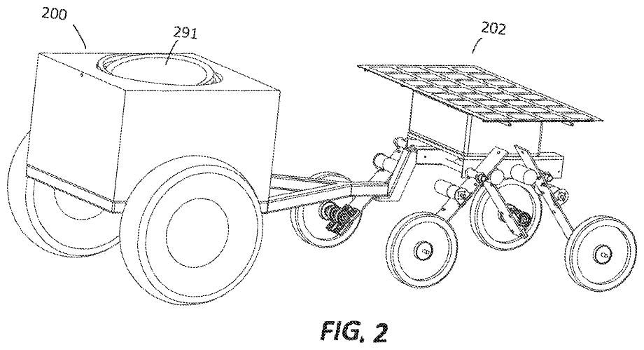

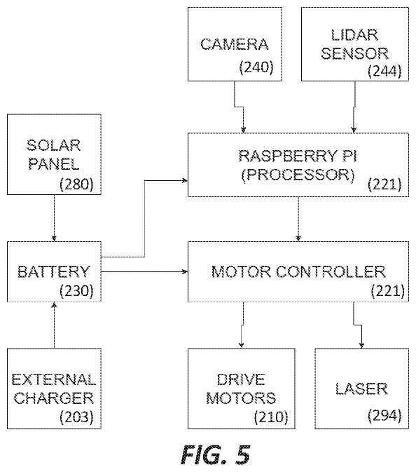

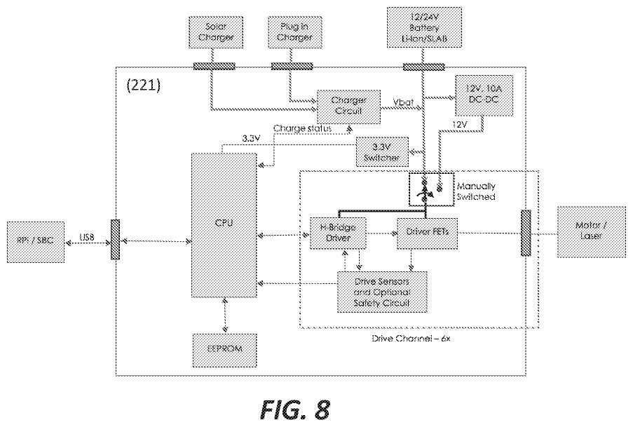

FIG. 5 is a flow chart showing the parts of the next embodiment. As shown in FIG. 1 this embodiment is a configurable ground utility robot GURU 202 having at least the following parts: an all-terrain mobile apparatus 210; a payload accepting apparatus 261; an onboard processor 221, as also shown in the diagram at FIG. 8 and flowchart in FIG. 9; at least one sensor 240 that communicates with said onboard processor 221; at least one energy beam payload device 290 connectable to the payload accepting apparatus 261, capable of creating an energy beam 294 having enough power to elevate an internal temperature of a subject 299 when the energy beam 294 is focused on the subject 299 and where the energy beam payload device 290 communicates with the onboard processor 221. The ground utility robot 202 also has a computer program 220 that at least performs the following functions: receives and interprets data from the at least one sensor 240; controls the mobile apparatus 210; focuses the at least one energy beam 294 on the subject 299; and controls the beam strength and time duration. Furthermore, this configurable ground utility robot 202 has an adjustment apparatus 297, controlled by a computer program 220, that is capable of moving and positioning the at least one energy beam payload device 290. The energy beam is typically one of a variety of beams, including a laser or infra-red beam 295, a lens focused light, as shown in FIG. 2, a microwave beam 293, or a microwave emitter 292. This GURU 202 has an onboard solar array 280, an onboard fuel cell 230. Also, there can be a variety of sensors, including a camera 241, an infrared camera 242, motion sensors 243, Lidar 244, microphones 245, Audible devices 246, LED lights 247, and a GPS system 248. The GURU in this embodiment is used for weeding and the subject in this case is a non-crop or weed. However, it could also be a bug or pest. The configurable ground utility robot of this embodiment can also be used as a crop collecting apparatus, where the subject is a crop stem, and where said energy beam is used to cut the crop stem so that a crop can be placed in the crop collection apparatus.

This first Embodiment is a weed suppression system having an energy beam control system that uses the focused energy beam. In this embodiment the GURU is capable of negotiating varying terrains, the onboard processor with onboard software, the at least one sensor affixed to the mobile apparatus (part of the GURU) that communicates with the onboard processor, the at least one energy beam payload device capable of creating the energy beam having enough strength to elevate an internal temperature of a subject (in this case, a non-plant) when the energy beam is focused on the subject and where the energy beam payload device communicates with the onboard processor, further having an adjustment apparatus, or turret or other adjusting device, connected to or part of the at least one energy beam payload device or, in the alternative, connected to or part of the mobile apparatus, to position the energy beam payload device so that the energy beam can focus on the subject, and the onboard computer program/software that runs the weed suppression system performs at least the following functions: controls the mobile apparatus; receives and interprets data from the at least one sensor; controls the adjustment apparatus, which might be the robot itself to move and position the at least one energy beam payload device so that the energy beam from the at least one energy beam payload device is focused on the subject; and controls the beam strength and a duration of the energy beam.

This weed suppression system could use a tractor or other man-controlled devices to move about the growing area, or territory. However, the preferred means of moving the system around the territory is to use the Ground Utility Robot (GURU) described in detail above. As set out above, this GURU can be used for many different chores, including assistance with weed control, snow removal, moving cargo around, monitoring weather, security, predator control, pest control, harvesting crops, or any of a variety of tasks. In this embodiment the GURU is used in part to move the weed suppression system around the territory. The present invention consists of the software and hardware that identifies the subject, or here, non-crop, approaches it in challenging terrain (it can be hillsides or any other terrain) and then uses the energy beam to suppress or destroy the crop. The GURU can be of a variety of forms, such as the insect-like apparatus that uses insect-like locomotion via the insect leg articulation, to focus the energy beams to suppress/destroy the non-crop, or it could be the wheeled mobility apparatus as described above, or any other configuration that allows for mobility around the varied terrain.

Specifically, in this embodiment there is an autonomous robot system having at least one autonomous, field deployable robot, or GURU, zero or more fueling docking ports, software that will allow the GURU to navigate in either a structured or unstructured environment and where the GURU uses the energy beam from the energy beam payload device to remove weeds. The GURU in this embodiment is programmed to identify and discern weeds from crops so as to not destroy all the crops but rather, to destroy only the offending weeds. And more specifically, the system is designed to really only identify the crop. There are hundreds of types of weeds and thus programming and learning all the weeds is difficult and unnecessary. What is really only necessary is to identify the plant that is not be killed, suppressed or inhibited. In this way the system will attack anything that is recognized as non-crop and because of this simplistic solution the software must only recognize crop and non-crop. The GURU of this system uses a focused energy source to eradicate the non-crop. In this particular embodiment it should be noted that it is the energy beam payload device that is adjustable. In order for the system to work the energy beam must be focused on the subject non-crop. In this configuration the GURU works in conjunction with the energy beam payload device to focus the beam. This is accomplished by the GURU getting in place and the payload device moving to focus on the weed. In a later described embodiment the GURU itself is the adjusting device.

Currently many systems designed to remove or kill weeds use either chemicals to kill or mechanical action to attempt to uproot and remove the weed from the ground. These two current systems are ineffective for several reasons. First, the chemicals can harm the other plants and more importantly they can harm humans who consume the crops. Second, it is not guaranteed that the chemical will actually kill the weed. Third, it is not environmentally friendly to use chemicals for farming. With respect to the mechanical apparatus and weed removal, again, it is not guaranteed that the weed will be removed and killed, and there is a danger that when trying to remove the weed that the crop will mistakenly be removed as well. The present application also utilizes a mechanical weed removal application but contrary to the existing art, uses a different type of weed and plant identification system in order to prevent plant damage. The presently described embodiment, however, uses a non-chemical, non-mechanical means to eradicate weeds.

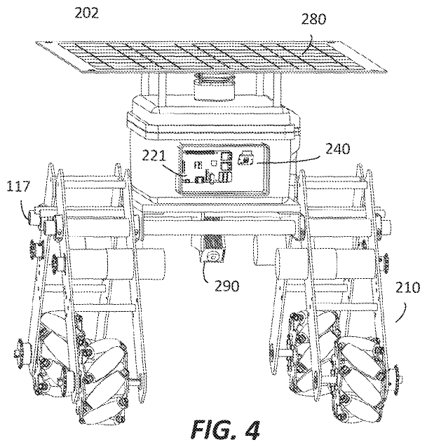

In this second embodiment, as shown in FIG. 4, the GURU itself is configured so that it can move its body to align the focused energy on the non-crop. The GURU is nimble enough and has enough ability to position and align its body to focus the energy on the selected non-crop. The GURU can be any of a variety of configurations, but two envisioned options are set out herein. One, is the GURU described above having the chassis, electric motors, the mobility apparatus (such as caterpillar tracks or wheels), onboard sensors, electronics, fuel cell, etc. and a means to connect the energy beam payload device to the GURU. This device also can include a linkage chassis and pivoted suspension. These two particular apparatus, along with other types of adjustable apparatus, allow the GURU to have an adjustable height and a unique configurability. In this configuration there is the configurable ground utility robot having an adjustable all-terrain mobile apparatus; an onboard processor; at least one sensor that communicates with the onboard processor; at least one payload secured to the ground utility robot; a computer program that at least performs the following functions: receives and interprets data from the at least one sensor; and adjusts movement, height and position of the adjustable all-terrain mobile apparatus based on the data so that said payload can execute a task. In this embodiment the configurable ground utility robot also features the linkage chassis and the pivoted suspension as set out above. This allows the device flexibility and adjustability. Furthermore, in the preferred embodiment the payload is an energy beam and the task is weed or pest suppression. However, it could also be used for harvesting. Ideally, the energy beam is a laser, a lens focused light, an infra-red beam, a microwave beam, or a microwave emitter and this GURU is controlled by the computer program to adjust the GURU so that the GURU is used to position the energy beam payload device. Moreover, it also desirable for the configurable ground utility robot to have an onboard solar array and an onboard fuel cell.

Although it is preferable to use the energy beam for weed and pest eradication, it is also possible to use a weed drill. In this configuration the payload is the weed drill and the adjustable all-terrain mobile apparatus is controlled by the computer program to position and control the weed drill payload device. The weed drill targets the identified weed and cleanly separates, lifts and removes the weed from the ground.

In yet another configuration, a GURU has an insectoid body featuring a main body or chassis and a variety of legs that allow for mobility over a variety of terrains. The energy powering the energy beam can be from a variety of sources, but it is desired that the energy come from an infra-red source, a laser source, a microwave beam from a focused microwave emitter, or even from focused sunlight by using a simple optical lens as described above.

When shaped as the field deployed arachnid bodied GURU the GURU ideally carries its electronics and fuel source inside a central body (similar in shape to a spider. The insect-like legs allow the GURU to navigate unstructured, inclined terrain with a minimum foot print and surface contact area, as to not disturb the field. This leg configured also allows the GURU to move its body to focus on the identified non-crop below. One of the other unique aspects of this invention and configurations is that it can operate most anywhere. Many previous adaptations and attempts to create weed killing robots rely on structured field configured. This is not true with the present arachnid bodied GURU.

The ultimate goal for autonomous weed removal is to eliminate the use of herbicides. The arachnid autonomous robot GURU of the present invention use the insect like chassis, with between two to six long legs of variable length (6 ft nominal). In the center, the “insect body” can carry batteries and/or solar panels, and on the underside, sensors, such as cameras for identification of weeds. In addition, as described above, there can be a microwave focused emitter, or infra-red laser (TBD) that destroys the identified non-crop.

As shown in FIG. 2, an alternative to micro wave or laser, for high insolation areas is focused sunlight where a large, simple, optical lens is placed in the center of the robot body that focuses sun rays on the non-crop subject, rapidly increasing its temperature and essentially burning/boiling the stem, as close to the ground as feasible.

In application, the GURU having the wheeled mobility apparatus, moves slowly across a geo-fenced target location, able to navigate variable, steep or flat terrain. It ideally can deal with both ordered vegetable rows or unstructured fields of plants (wheat, corn, etc). The GURU operates 24/7, with a duty cycle determined by its ability to recharge (either through solar, or inductive magnetic field charging using the base station). As detailed below, the GURU may also be able to return to a fueling docking port when its charge reaches critical level and these docking stations or fueling ports can be either at a central location or scattered about the service area. Multiple GURUs operating on large fields will enable early and often weed removal, preventing weeds taking over in clusters.

From an operational standpoint, the autonomous robot system is designed to be available to everyone, not just the wealthy or large corporate farm companies. The GURUs can be leased and rotated between farms using the above described reservations system. This design presents a system to lower income farmers that otherwise could not afford to purchase and use the bots or the system. This system can be used by small to medium sized independent farmers, medium to large farms, and consumer gardens (with smaller scale version), and even now other applications and users are continually emerging.

In this present application the user will employ the described GURU to eliminate weeds. To more specifically define the invention set out above, we now describe the GURU operation when used as the weed suppression system. First, the GURUs are reserved by a customer using the above described reservation system, they are then delivered to the customer's site and are placed on a field and are geo-fenced so they know the virtual boundaries of the field using either GPS, visual cues, Wi-Fi beacons or any other type of virtual fencing system. The GURU uses machine vision to identify the non-crop, approach it, then tilts its body in such a way that it can focus the direct energy beam from the energy beam payload device that will heat and destroy the subject non-crop. The energy beam can be one of many embodiments but below are three specific embodiments that could be utilized for the present application.

First is a focused sun energy using a large (12″ or larger) diameter optical lens, attached to the GURU, that is positioned autonomously by the GURU, so the peak energy density is on the stem of the identified non-crop. Just a few seconds of intense focused sun energy is enough to heat up and burn the non-crop stem, suppressing its growth significantly. The diameter of the lens could be smaller or larger depending on lens strength, regional sun, or any number of additional variables, but is ideally 12 inches or larger.

A second type of energy beam is a focused microwave emitter that could also be used to heat up the water molecules inside the non-crop (and on its surface) essentially boiling its stem and leaves. The same technology as described above allows us to identify the non-crop's stem and leaves and to then move the GURU so that the microwave beam dispersed from the focused microwave emitter is optimally placed to eradicate or at least slow down the non-crop's growth.

A third energy beam option is an infrared laser beam, preferably in the order of 30 W power rating, with a surface area of a few millimeters, again focused on the non-crop stem. Just a few seconds allows the laser beam to burn through the non-crop stem and create holes in the leaves and non-crop body.

Essentially it does not matter what type of energy beam is used to eradicate the non-crop, as long as it provides enough energy to destroy the non-crop internally but not enough energy to cause fires.

As mentioned above, a final embodiment would include a mechanical means to eradicate and eliminate weeds. In this embodiment the same GURU is used to align and focus the mechanical apparatus. In this particular embodiment the weed drill is used instead of the focused energy beam. The weed drill attachment is similarly affixed to the GURU as the above described energy beam payload device. However, instead of using one of the preferred energy beams (such as the focused energy from the lens, or the focused microwave emitter, or the microwave beam, or laser beam) the present application resorts to a more traditional mechanical means. The difference lies in two important elements. First, the present system uses the sophisticated weed recognition software described above in order to minimize the elimination of plant rather than non-plant. And second, the system uses the new, efficient and proficient weed drill as a means to remove offending weeds. In this embodiment the weed is recognized, the GURU positions itself and the weed drill so that the weed drill can be deployed into the soil. The rotating drill then literally pulls the weed from the ground, preventing future growth of the week. Alternatively, a spinning device, similar to a weed wacker, could be used to cut the weed off as close to the ground as possible.

In brief summary, the autonomous robot system has robots, the computer program to run the robots, and potentially refueling ports or charging ports. The robots from this system are sent out into the field in search of the non-crops. Once the robot identifies the non-crop it uses the energy beam that is emitted from the energy device or the mechanical means to eradicate the non-plant. After destroying the non-crop, the robot moves on in search of the next non-crop. This same system can be used for the suppression of pests also, as will be described next.

### Pest Bots

The second application for the above described GURU is a pest control system having an energy beam control system that uses a focused energy beam. As this system is identical to the system used to eradicate weeds the Figure numbering system remains the same, as do many of the descriptions and parts. In this embodiment there is the GURU having the all-terrain mobile apparatus, the onboard processor, onboard software, at least one sensor affixed to the mobile apparatus that communicates with the onboard processor, at least one energy beam payload device capable of creating an energy beam having enough strength to eliminate pests when the energy beam is focused on the pest and where the energy beam payload device communicates with the onboard processor, further having a turret, or an adjustment apparatus connected to the at least one energy beam payload device to position the energy beam payload device so that the energy beam can focus on the pest, and the computer program, or onboard software that runs the pest control system at least performs the following functions: controls the mobile apparatus receives and interprets data from the at least one sensor; controls the adjustment apparatus to move and position the at least one energy beam payload device so that the energy beam from the at least one energy beam payload device is focused on the pest; and controls the beam strength and a duration of the energy beam.

This embodiment is identical to the first embodiment except for the application and use of the beam. The all-terrain GURU will behave similarly to that of the weed control GURU but rather than heating up non-crop subject the beam will focus on pest subject in order to eliminate the pest.

Obviously, the software will be different as the GURU will now have to recognize a variety of moving subjects, rather than just non-crops subject. This can be accomplished in a couple of ways. First, it could be programmed similar to the non-crop application where the GURU could attack anything “non-human” or “non-mammal.” The GURU could utilize the sensors to pick up body temperature and therefore only attack pests that have a body temperature lower than mammals. Alternatively, it could be programmed to actually identify a variety of pests. This could be done through an initial data upload, or an initial data upload combined with learning and possibly combined with the human assisted machine learning, as described above. In any case, the process is basically the same. The device identifies the subject, the energy beam is focused and deployed, and the subject is eradicated.

The GURU could also do double duty by suppressing weeds and controlling pests. The GURU could be programmed to move from crop plant to crop plant, suppressing weeds and by eliminating any pests around the crop using a single energy beam. Or, the GURU could be equipped with multiple energy beams such that one or two beams would perform the weed suppression task while other beams would perform pest control.

In most ways the pest control system is identical to the weed suppression system described above except for the task, i.e., eliminating pests rather than suppressing weeds, so a more detailed description of the system will not be included here.

Harvesting Bots. Yet another embodiment that utilizes the energy beam is a harvesting system. This embodiment is slightly different than the previous two embodiments in that the controlled energy beam is used to cut produce from the stem and then the collecting apparatus is used to collect the crops. This embodiment features the configurable ground utility robot having the adjustable all-terrain mobile apparatus; the collecting apparatus; the onboard processor; the at least one sensor that communicates with the onboard processor; at least one payload secured to said ground utility robot; and a computer program that at least performs the following functions: receives and interprets data from the at least one sensor; adjusts movement, height and position of the adjustable all-terrain mobile apparatus based on the data so that the payload can execute a task. In this case the payload is a crop stem severing device and the task is harvesting. In this application the crop stem severing device utilizes the energy beam to sever the stem and free the crop. Here, the crop is delivered into the collecting apparatus after the crop stem is severed by the severing device. This apparatus provides a clean, efficient means to harvest low lying crops, and possibly high fruit crops as well, such as apples or grapes or other produce. Ideally the GURU can be used for pest and weed control along with harvesting. As noted above, the desire is to have the systems run entirely on renewable energies, so it is also preferable for the system to have an onboard solar array and the onboard fuel cell.

The collecting apparatus can be affixed to the GURU or it could be another GURU that either is attached or just follows the first GURU. Also, it could follow behind and collect the produce or it could lead and collect the produce. This embodiment features an energy beam control system having an all-terrain mobile apparatus; an onboard processor; at least one sensor affixed to the mobile apparatus that communicates with the onboard processor; at least one energy beam device capable of creating an energy beam having enough strength to sever a produce stem when the energy beam is focused on the produce stem and where the energy beam device communicates with the onboard processor; an adjustment apparatus connected to the at least one energy beam device to position the energy beam device so that the energy beam can focus enough energy to sever the produce from the stem; a collection apparatus to collect, hold and transport the produce after the produce stem is severed; and a computer program that runs a produce harvesting system and at least performs the following functions: controls the mobile apparatus; receives and interprets data from the at least one sensor; controls the adjustment apparatus to move and position the at least one energy beam device; controls the beam strength and duration so that the energy beam can cut the produce stem; and controls and monitors the collection apparatus.

As noted, this system is somewhat different from the previous two embodiments and is in some ways more difficult in application. This system would utilize the same GURU as the previous embodiments. It would also utilize similar programming to control the energy beam but rather than using the beam to suppress a weed or kill a pest it would be focused on a plant stem for a long enough time to sever the stem in half, thus releasing a crop from the stem. Again, the beam would have to be controlled enough to just cut the stem and not harm the plant or cause fires in the crop field.

In addition to the cutting procedure this embodiment would have a collection apparatus to retrieve the crops once severed and cut from the stem. This system would require some means to collect the crops, i.e., fruits, nuts, etc. and place them in the collection apparatus. The programming would be somewhat more complicated as the system is now not just destroying weeds or pests but is working to not injure the crop and then collect the crop after it is separated from the stem.

Autonomous predator identification and conflict reduction system. Another embodiment or use for the GUR is as an autonomous predator identification and conflict reduction bot. A side benefit of the 24/7 duty cycle farming robot is the ability to identify predators using the camera and or a thermal infrared camera, a microphone, motion sensors and then using noise, light, odors or other non-lethal means to prevent them from getting close to the geo-fenced area. The GURU could be used for a variety of predator deterrents, including those that could attack the crops, those that could attack other animals on the property, those that could attack humans on the property, or those that are there for other illegal activity, be it trespassing, theft, vandalism, or destruction of property.

In order to deter animals from attacking and eating the crops, there are basically three different types of repellants that can be used. They are odor-based repellants, taste-based repellants and instinctual fear-based repellants. The robots could apply natural, odor and/or taste-based deterrents to the plants through a spray or some other means. This could be done in conjunction with the daily activities of eradicating weeds and pests. In some instances, a repellent product will utilize more than one cause of action. For example, a spray on repellent may have ingredients that produce both a foul odor and also include an ingredient that makes the plant less attractive from the sense of taste. There are many repellants available that are entirely natural and do not use any chemicals whatsoever and these would be the preferred type.

In addition, the bots could also use noise and light, that work well as fear-based repellants. The bots could be programmed to dissuade and prevent predators from entering the controlled area through the use of loud noise, sirens, flashing lights, laser lights, or a combination of these deterrents. These same deterrents could be used on predators that are attacking the plants as those that are there to attack livestock or other animals. Obviously, these would be larger animal breeds. These means could be used to scare aware predators and thus prevent loss of livestock, animals, stored crops etc. This gives the user peace of mind knowing that his property is secure and his investment safe.

Aside from animal predators the bots could serve as a security system to prevent prowlers and unauthorized persons from breaching the perimeter. This could be done by using motion detection where if motion is detected, and a person identified, the bot could then send alerts to the owner or the Control Company to either activate alarms, trigger sirens or even call 911. Obviously, the bots could also use lights, lasers, sirens and horns as an initial means of warning and scare tactic. Then, if the bot still senses motion or danger it could alert the Control Company or the Police. In addition, the system could include facial recognition to recognize known users, such as Control Company employees, or the Customer, in order to prevent false alarms or warning.

Weather station and Soil Testing. Yet another use for the bots is that of a weather station to monitor and report into the Control Company, local weather stations, governmental agencies, data collection centers, or anyone wanting access to his information, either on a free or paid for basis. A sensor suite already provides key telemetry per robot, and stream processing by remote peers can produce detailed weather/hydrology data available for farming optimizations. Along with reporting weather the robot can compile, store and analyze the collected weather data. This information will provide useful data to the user through weather patterns, rain fall measurements, temperature measurements, humidity measurement, and a variety of other measurements that will assist in successful growing seasons and better crop production. The bot could also take soil samples and perform soil testing as it roams the fields. Samples could provide a variety of information, depending on the type of sensors utilized. Information could include color, compaction, soil moisture content, organic content, pH, profile, structure, temperature and texture, just to name a few. These tests help establish organic matter, erosion factors, aeration, available nitrogen and soil fertility. These tests can determine soil fertility, or the expected growth potential of the soil which indicates nutrient deficiencies, potential toxicities from excessive fertility and inhibitions from the presence of non-essential trace minerals. Labs typically recommend 10-20 sample points for every forty acres of field and they recommend creating a reference map to record the location and quantities of field samples in order to properly interpret test results. Something that used to be done manually can now be done by the GURU [[202 with better tracking, sampling and mapping. Testing is also performed on-site using the onboard software and computer. This eliminates the need to remove the soil from its natural ecosystem, thus preventing any chemical changes that might occur during a move. Having sophisticated software and computer systems in the field removes the need for “do-it-yourself” testing kits and provides a much more robust and thorough analysis. If the bots are working adjacent fields it would also be helpful to compare the soils in the region. The testing is included with or could be purchased in addition to the standard tasks assigned to the bots.

AI LEARNING. The GURU ideally will be connected online and will have learning ability so that it can continually learn, using connection with online software, supplied by a centralized control center or System Manager (such a cloud computing cluster of computing nodes), and also improve overall performance through machine learning and crowdsourcing, between all deployed robots, of all weed suppression images and actions, pest data, predator data and weather data. The GURU uploads images of all plants, animals, predators, weather conditions, soil conditions, soil tests, and environments it experiences, along with its actions. A machine learning platform processes continuously the inputs (sensor data) and outputs (robot actions) and using reinforcement learning it adapts the parameters used by all GURU, used to identify plants, pests, move, control the robot's actions, etc. This is essentially a feedback control system that uses data from all the active robots and closes the loop by adjusting configuration parameters, and code, on all the robots. Additionally, the robots self-update when new parameters or code is available.

Energy Supply. Ideally, the bots will run entirely off the on-board solar arrays. However, it is envisioned that they could be powered from a variety of sources. They will be entirely free of the grid and will work off renewable energy sources at their location. This can be accomplished through a variety of sources and methods, the full chain of energy capture, storage, distribution, and use in mobile robots is described next. The energy source for the robots could come from a singular source or it could be a combination of a variety of sources. These could include solar, wind, hydro, thermal, regenerative breaking, but this system could also feature a hydrogen or methane economy that provides a net positive benefit to the environment and its users. To achieve this lofty goal of independence the system must be able to capture enough energy to keep the robots operational and to keep the entire system operational. This can be accomplished through a variety of energy capture systems that include but are not limited to the following.

Solar. As shown, each customer deploying one or more robots is offered a fueling port equipped with properly sized solar panels and possibly a battery within the fueling port to store excess power that can then be sold back to the grid or to use when solar generation is not available. The solar array solar panels ideally are flexible panels at least 2 W minimum. If possible, the station is grid to offer net metering benefits. The battery is present to provide buffering of energy during low insolation intervals. It is entirely possible that the robots could be free of charge or at reduced service rates in exchange for the control company's ability to sell back power to the grid. This is beneficial to both parties.

The bots can autonomously recharge by returning to the fueling port. The fueling port is equipped with a square weather/water proof floor mat, placed over a level surface. Ideally the mat is approximately 24″×24″, depending on the size of the robot. The mat is an inductive charging port and contains an inside transmitter coil used for inductive charging. Each robot has an inductive charging plate that has another coil (receiving antenna) on its underside, that when positioned above the charging port enables wireless charging. The minimum distance required between the robot underside and the floor mat is approximately 12″ but this may change as technology advances. Dimensions and specifications will be determined as costs and physical constraints are considered.

### Methane

Another alternative, or additional source of energy, is methane. Methane capture and use provides a unique opportunity. Methane is produced by different processes at farm environments. For example, enteric production in all animals, fore stomach production in ruminants, and general decay processes of organic waste (farm waste or animal waste) are some of the available sources of methane, just to mention a few. The control company can offer the opportunity to all sites with methane product, to capture and use the product for their own robots and additionally, to sell the methane to other users, including other control company robot owners or leasing customers.

When using methane to recharge the bots it is ideal for each bot to have its own compact fuel cell that converts the methane to electric power to drive the bot. The compact fuel cell is tuned to methane fuel as hydrogen source. It is a hybrid energy source (fuel cell+Li-Ion battery kept warm by the fuel cell heat byproduct). Bots featuring and using the fueling port have an autonomous navigation and docking system that guides each bot to the fueling port for refueling. There are many different ways to achieve this, including an autonomous navigation software solution that identifies the fueling port using visual cues that are part of the station itself. The operator has the ability to teach the robot the location of the fueling port, through a “home tour” approach, so the robot can localize and navigate to the station. In addition to visual cues, a wireless emitter can also be used, so the robot can identify and approach the fueling port with precision, even in inclement weather.

The mechanism of refueling will obviously depend on the type of fuel used. If there is electricity present, such as from the grid or a solar panel supplied power to the inductive charging port then the induction charging system could be utilized. However, as described above, methane could be used, or it could even be a combination of both electricity and methane. When using the charging port bots have an alert system that notifies the bot that it is low on fuel and that it needs to go back and refuel. The bots could also use regenerative braking to provide additional charge while in use.

If methane is used then the control company will provide controls and services in addition to those listed above. These services include but are not limited to offering equipment to capture and store the methane. This equipment could be sold outright to the customer or the control company could lease the equipment to the customer. Also, the control company could provide transportation on site or to off-site locations for stored methane when capacity is reached. Methane delivery could also be a provided service where the control company delivers methane to other customers that use methane fuel powered robots and devices. In many of these situations both parties' benefit.

There are some drawbacks that need to be overcome but with continued investment and technology advancement these constraints will be removed. However, at present there are obstacles to overcome, specifically, cost, duty cycle duration, life cycle and the maintenance interval.

While the present disclosure has been described as having certain designs, the various disclosed embodiments may be further modified within the scope of the disclosure. This application is therefore intended to cover any variations, uses, or adaptations of the disclosed embodiments using its general principles. Further, this application is intended to cover such departures from the present disclosure as come within known or customary practice in the relevant art.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. An implement attachment apparatus for use with and attachment to a ground utility robot comprising:
a three-point hitch frame comprising:
at least one lower lift arm affixable to said implement;
at least one leveling arm;
at least one top link arm affixable to said implement;
at least one electric linear actuator;
at least one support arm affixable to said ground utility robot; where
said three-point hitch frame is securable to said ground utility robot and to said implement;
a power take-off system comprising:
a power supply located on said ground utility robot;
a gearbox assembly having:
a first side connectable to at least one motor assembly;
an internal gearing mechanism;
at least one power take-off shaft extending from a second side of said gearbox assembly; where
said power take-off shaft has a first end engageable with said internal gearing mechanism;
a second end connectable to said implement;
said power supply provides power to said power-take off shaft that then powers said implement;
a safety system comprising:
a variety of sensors where said sensors actively sense for abnormalities;
an onboard computer;
a safety program utilizing processing logic on said onboard computer; and
if an abnormality is deemed a hazard then said safety program shuts down said power-take off system, said ground utility robot, or both.

2. The implement attachment apparatus of claim 1 where:
said onboard computer controls:
said ground utility robot;
said power supply;
said implement; and
said safety system.

3. The implement attachment apparatus of claim 2 where:
said variety of sensors includes cameras, heat detection sensors, motion detection sensors and sensors in a motor control logic;
said variety of sensors are positioned at different locations on said ground utility robot, on said implement attachment apparatus or both; and
said variety of sensors work together to identify living or non-living things.

4. The implement attachment apparatus of claim 3 where:
if said living things are detected then said sensors communicate that information to said onboard computer;
said onboard computer deems said living thing as a human or an animal and then as said hazard; and
said safety program cuts power to said power take-off, to said ground utility robot, or both.

5. The implement attachment apparatus of claim 4 where said ground utility robot further comprises:
at least one solar panel array;
said power supply is at least one battery;
said at least one solar panel array charges and re-charges said at least one battery; and where
said at least one battery provides power to said ground utility robot, said safety system and said implement.

6. The implement attachment apparatus of claim 5 where said implement attachment apparatus and said implement are attached to a first end of said ground utility robot and a second implement attachment apparatus and a second implement are attached to a second end of said ground utility robot.

7. The implement attachment apparatus of claim 5 where:
said implement attachment apparatus and said implement are attached to a second end of said ground utility robot; and
a counterweight is attached to a first end of said ground utility robot.

8. The implement attachment apparatus of claim 7 where said counterweight is a battery.

9. A powered implement system comprising:
a ground utility robot;
at least one three-point hitch;
an apparatus to connect said at least one three-point hitch to at least one end of said ground utility robot;
at least one power take-off;
at least one implement connectable to said at least one power take-off; where
said ground utility robot powers said at least one power take-off and said at least one implement;
a computer system that controls said ground utility robot and said power take-off; a power take-off safety system comprising;
at least one sensor that senses objects that are near or in a path of said ground utility robot;
a computer and safety program that can differentiate non-living from living things;
an automatic shut-off for said power take-off;
an automatic shut-off for said ground utility robot;
if said safety program defines said object as living then said safety program initiates an automatic shut-off of ground utility robot, said power take-off, or both; and
when said living object is no longer near or in said path of said ground utility robot, then said safety program resumes said ground utility robot, said power take-off, or both.

10. The implement attachment apparatus of claim 9 where said ground utility robot further comprises:
at least one solar panel array located on said ground utility robot;
said power supply is at least one battery;
said at least one solar panel array charges and re-charges said at least one battery; and where
said at least one battery provides power to said ground utility robot, said safety system and said implement.

11. The implement attachment apparatus of claim 10 where said implement attachment apparatus and said implement are attached to a first end of said ground utility robot and a second implement attachment apparatus and a second implement are attached to a second end of said ground utility robot.

12. The implement attachment apparatus of claim 10 where:
said implement attachment apparatus and said implement are attached to a second end of said ground utility robot;
a counterweight is attached to a first end of said ground utility robot; where
said counterweight is a battery.

13. A ground utility robot and implement attachment apparatus comprising:
said ground utility robot;
at least one implement;
at least one solar panel;
at least one battery that is chargeable by said at least one solar panel;
a power take-off system that is connected to said ground utility robot;
said at least one implement is connected to said power take-off;
said battery powers said ground utility robot and said implement;
a safety system that comprises:
a computer;
a safety program that utilizes a processing logic on said computer; where
said safety program initiates precautionary measures that are carried out by said ground utility robot and said power take-off system if an object comes within a predefined distance from said ground utility robot and implement attachment apparatus.

14. The ground utility robot and implement attachment apparatus of claim 13 where said safety system can categorize said object as human, animal or non-living.

15. The ground utility robot and implement attachment apparatus of claim 13 where said precautionary measure is to cut power to said power take-off, to said ground utility robot, or both until said object is no longer in said predefined distance.

16. The ground utility robot and implement attachment apparatus of claim 15 where said precautionary measure is to avoid said object until said object is no longer in said predefined distance.

17. A method of hazard avoidance by a ground utility robot and an implement comprising the steps of:
providing a ground utility robot, a computer, at least one implement, at least one solar panel, at least one battery, at least one power take-off, and an operating and controlling program installed on said computer;
connecting said at least one power take-off to said ground utility robot;
connecting said at least one implement to said at least one power take-off;
charging said at least one battery by said at least one solar panel;
powering said ground utility robot, said at least one power take-off and said at least one implement with said at least one battery;
a safety system comprising:
said computer;
a safety program;
at least one sensor;
operating and controlling said ground utility robot and said at least one power take-off using said operating and controlling program;
said ground utility robot commencing a preassigned task;
using said at least one sensor for sensing, obtaining data and communicating said data to said computer;
processing said data on said safety program;
analyzing said data for an obstacle or no obstacle;
recognizing said obstacle;
initiating at least one evasive measure if said obstacle is within a predefined distance of said ground utility robot or said at least one implement; where
said at least one evasive measure is one or more of the following:
changing said ground utility robot's directional path;
cutting power to said ground utility robot; and
cutting power to said at least one power take-off.

18. The method of hazard avoidance by a ground utility robot and an implement of claim 17 comprising the additional steps of:
using said at least one sensor for ongoing monitoring of said obstacle within said predefined distance of said ground utility robot and said at least one implement;
reversing said at least one evasive measure when said obstacle is clear from said predefined distance; and
restarting said preassigned task.

19. The method of hazard avoidance by a ground utility robot and an implement of claim 18 comprising the additional steps of:
assigning a value to said obstacle where said value is either human, animal or thing;
storing said value as a learned value; and
assigning a specific evasive measure based on said learned value.

20. The method of hazard avoidance by a ground utility robot and the implement of claim 19 comprising the additional steps of:
having at least one power take-off sensor constantly sensing and monitoring a current draw on said at least one power take-off;
setting a high-end current draw limit on said at least one power take-off; and
if said high-end limit is reached or exceeded then shutting down power to said at least one power take-off.
